(19) United States
(12) Patent Application Publication
(10) Pub. No.: US 2026/0217883 A1
(43) Pub. Date: Jul. 30, 2026

(54) ETHYLENE INTERPOLYMER PRODUCTS AND FILMS

(71) Applicant: NOVA CHEMICALS (INTERNATIONAL) S.A., Fribourg (CH)

(72) Inventors: Zengrong ZHANG, Calgary (CA); Fazle SIBTAIN, Calgary (CA)

(73) Assignee: NOVA CHEMICALS (INTERNATIONAL) S.A., Fribourg (CH)

(21) Appl. No.: 19/148,390

(22) PCT Filed: Jan. 18, 2023
(86) PCT No.: PCT/IB2023/050438

§ 371 Date: Jul. 16, 2025

(51) Int. Cl. C08F 210/16; B32B 27/08; B32B 27/32; C08J 5/18

(52) U.S. Cl. CPC C08F 210/16; B32B 27/08; B32B 27/32; C08J 5/18; B32B 2250/03; B32B 2250/242; C08F 2800/20; C08J 2323/08

(57) ABSTRACT

An ethylene interpolymer product having defined branching and unsaturation characteristics. The ethylene interpolymer product comprises: a first fraction having a molecular weight distribution index M_{w}/Mₙ of from 1.8 to 4.0; and a second fraction having a molecular weight distribution index M_{w}/Mₙ of from 2.0 to 6.0.

### TECHNICAL FIELD

The present disclosure generally relates to multicomponent ethylene interpolymer products and, in particular, relates to multicomponent ethylene interpolymer products with defined branching and unsaturation characteristics which have performance attributes that are advantageous in film applications.

### BACKGROUND ART

Multicomponent ethylene-based polymer compositions are well known in the art. One method to access multicomponent polyethylene compositions is to use two or more distinct polymerization catalysts in one or more polymerization reactors. For example, the use of single site and Ziegler-Natta type polymerization catalysts in at least two distinct solution polymerization reactors is known. Such reactors may be configured in series or in parallel.

Solution polymerization processes are generally carried out at temperatures above the melting point of the ethylene homopolymer or copolymer product being made. In a typical solution polymerization process, catalyst components, solvent, monomers and hydrogen are fed under pressure to one or more reactors. In a solution polymerization process, reactor temperatures can range from about 80° C. to about 300° C. while pressures generally range from about 3 MPag to about 45 MPag. The ethylene homopolymer or copolymer produced remains dissolved in the solvent under reactor conditions. The residence time of the solvent in the reactor is relatively short, for example, from about 1 second to about 20 minutes. The solution process can be operated under a wide range of process conditions that allow the production of a wide variety of ethylene polymers. Post reactor, the polymerization reaction is quenched to prevent further polymerization, by adding a catalyst deactivator, and optionally passivated, by adding an acid scavenger. Once deactivated (and optionally passivated), the polymer solution is passed to a polymer recovery operation (a devolatilization system) where the ethylene homopolymer or copolymer is separated from process solvent, unreacted residual ethylene and unreacted optional α-olefin(s).

Regardless of the manner of production, there remains a need to improve the performance of multicomponent ethylene-based polymer compositions in film applications.

### SUMMARY OF INVENTION

Provided in a first aspect is an ethylene interpolymer product comprising: from 30 to 45 weight percent of a first fraction having a molecular weight distribution index M_{w}/Mₙ of from 1.8 to 4.0; from 55 to 70 weight percent of a second fraction having a molecular weight distribution index M_{w}/Mₙ of from 2.0 to 6.0; wherein the ethylene interpolymer product contains detectable levels of long chain branching as characterized by a dimensionless long chain branching factor, LCBF, of ≥0.005; and wherein the ethylene interpolymer product has a sum of unsaturation of, SUM^{u}, ≥0.047 per 100 carbon; wherein the weight percent and the molecular weight distribution index of the first fraction and the second fraction are obtained by deconvoluting an experimentally measured molecular weight distribution of the ethylene interpolymer product, and wherein the weight percent of the first or second fraction is defined as the weight of the first or second fraction divided by the weight of the sum of the first fraction and the second fraction, multiplied by 100.

The second fraction of the ethylene interpolymer product has a non-comonomer index distribution, NCIDᵢ², having a value characterized by eq.(1a) and eq.(1b);

$${NCID}_{i}^{2} \leq 1.000 - 0.00201 ( log {M}_{i} - log {M}_{o} + 4.93 ) + 0. 0137 {( log {M}_{i} - log {M}_{o} + 4.93 )}^{2} - 0.00034 {( log {M}_{i} - log {M}_{o} + 4.93 )}^{3} \qquad eq . ( 1 a )$$

$${NCID}_{i}^{2} \geq 0.730 - 0.00388 ( log {M}_{i} - log {M}_{o} + 4.93 ) + 0.00313 {( log {M}_{i} - log {M}_{o} + 4.93 )}^{2} - 0. 069 {( log {M}_{i} - log {M}_{o} + 4.93 )}^{3} \qquad eq . ( 1 b )$$

wherein, Mₒ is a peak molecular weight that characterizes a molecular weight distribution of the second fraction when fit to a log-normal distribution and Mᵢ is an incremental molar mass that characterizes said molecular weight distribution;

wherein a first semi-log derivative of the NCIDᵢ², d(NCIDᵢ²)/d log Mᵢ, eq.(2),

$$d ( {NCID}_{i}^{2} ) / d log {M}_{i} = {β}_{1} + 2 {β}_{2} ( log {M}_{i} - log {M}_{o} + 4.93 ) + 3 {{β}_{3} ( log {M}_{i} - log {M}_{o} + 4.93 )}^{2} \qquad eq . ( 2 )$$

has a value of <−0.0001, coefficients β₀, β₁, β₂ and β₃ are generated by fitting the NCIDᵢ² to a third order polynomial, eq.(3),

$${NCID}_{i}^{2} = {β}_{0} + {β}_{1} ( log {M}_{i} - log {M}_{o} + 4.93 ) + {{β}_{2} ( log {M}_{i} - log {M}_{o} + 4.93 )}^{2} + {{β}_{3} ( log {M}_{i} - log {M}_{o} + 4.93 )}^{3} \qquad eq . ( 3 )$$

wherein the NCIDᵢ² is obtained by deconvoluting an experimentally measured non-comonomer index of the ethylene interpolymer product.

In some embodiments, the first fraction has a non-comonomer index distribution, NCIDᵢ¹, characterized by a first semi-log derivative, d (NCIDᵢ¹)/d log Mᵢ, having a value of zero, wherein Mᵢ is an incremental molar mass that characterizes a molecular weight distribution of the first fraction, and wherein the NCIDᵢⁱ is obtained by deconvoluting the experimentally measured non-comonomer index distribution of the ethylene interpolymer product.

In some embodiments, second fraction has a weight average molecular weight which is less than the weight average molecular weight of the first fraction.

In some embodiments, the ethylene interpolymer product has a density of from 0.910 g/cm³ to 0.930 g/cm³.

In some embodiments, the ethylene interpolymer product has a melt index I₂ of from 0.5 dg/min to 1.5 dg/min.

In some embodiments, the ethylene interpolymer product has a composition distribution breadth index, CDBI₅₀ of from 50 to 75 weight percent.

In some embodiments, the ethylene interpolymer product has a dimensionless Long Chain Branching Factor, LCBF, of <0.04.

In some embodiments, the ethylene interpolymer product has a dimensionless Long Chain Branching Factor, LCBF, of ≥0.01.

In some embodiments, the ethylene interpolymer product has a sum of unsaturation of ≤0.07 per 100 carbon.

In some embodiments, the ethylene interpolymer product has a molecular weight distribution index M_{w}/Mₙ of from 2.5 to 5.0.

In some embodiments, the ethylene interpolymer product comprises from 1 to 10 mole percent of one or more than one α-olefin.

In some embodiments, the ethylene interpolymer product comprises from 1 to 8 mole percent of one or more than one α-olefin.

In some embodiments, the one or more than one α-olefin is selected from the group comprising 1-hexene, 1-octene and mixtures thereof.

Provided in a second aspect is a film layer comprising the ethylene interpolymer product as defined in the first aspect.

In some embodiments, the film layer is a blown film.

Provided in a third aspect is a multilayer film structure comprising at least one layer comprising the ethylene interpolymer product as defined in the first aspect.

In some embodiments, the at least one film layer is a blown film.

In some embodiments, the multilayer film structure comprises three layers. In some embodiments, the multilayer film structure comprises at least three layers. In some embodiments, the multilayer film structure comprises five layers. In some embodiments, the multilayer film structure comprises seven layers. In some embodiments, the multilayer film structure comprises nine layers.

The at least one layer as defined in the third aspect may be a core layer in the multilayer film structure. The core layer may be between, for example sandwiched between, at least two other layers.

Provided in a fourth aspect is a multilayer film structure comprising a sealant layer in which the sealant layer comprises the ethylene interpolymer product as defined in the first aspect.

In some embodiments, the multilayer film structure comprises one sealant layer. In some embodiments, the multilayer film structure comprises two sealant layers.

### BRIEF DESCRIPTION OF THE FIGURES

FIG. 1 compares the non-comonomer index distribution of the second fraction NCIDᵢ² in Examples 1-13.

FIG. 2 compares the first semi-log derivative of the non-comonomer index distribution of the second fraction in Examples 1-13.

### DEFINITION OF TERMS

Other than in the examples or where otherwise indicated, all numbers or expressions referring to quantities of ingredients, extrusion conditions, etc., used in the specification and claims are to be understood as modified in all instances by the term “about”. Accordingly, unless indicated to the contrary, the numerical parameters set forth in the following specification and attached claims are approximations that can vary depending upon the desired properties that the various embodiments desire to obtain. At the very least, and not as an attempt to limit the application of the doctrine of equivalents to the scope of the claims, each numerical parameter should at least be construed in light of the number of reported significant digits and by applying ordinary rounding techniques. The numerical values set forth in the specific examples are reported as precisely as possible. Any numerical values, however, inherently contain certain errors necessarily resulting from the standard deviation found in their respective testing measurements.

It should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values.

Unless expressly indicated otherwise, the various numerical ranges specified in this application are approximations.

All compositional ranges expressed herein are limited in total to and do not exceed 100 percent (volume percent or weight percent) in practice. Where multiple components can be present in a composition, the sum of the maximum amounts of each component can exceed 100 percent, with the understanding that, and as those skilled in the art readily understand, that the amounts of the components actually used will conform to the maximum of 100 percent.

In order to form a more complete understanding of this disclosure the following terms are defined and should be used with the accompanying figures and the description of the various embodiments throughout.

As used herein, the term “monomer” refers to a small molecule that may chemically react and become chemically bonded with itself or other monomers to form a polymer.

As used herein, the term “α-olefin” or “alpha-olefin” is used to describe a monomer having a linear hydrocarbon chain containing from 3 to 20 carbon atoms having a double bond at one end of the chain; an equivalent term is “linear α-olefin”.

As used herein, the terms “polyethylene”, “polyethylene polymer” or “ethylene polymer”, refers to macromolecules produced from ethylene monomers and optionally one or more additional monomers; regardless of the specific catalyst or specific process used to make the ethylene polymer. In the polyethylene art, the one or more additional monomers are called “comonomer(s)” and often include α-olefins. The term “homopolymer” refers to a polymer that contains only one type of monomer. An “ethylene homopolymer” is made using only ethylene as a polymerizable monomer. Common polyethylenes include high density polyethylene (HDPE), medium density polyethylene (MDPE), linear low density polyethylene (LLDPE), very low density polyethylene (VLDPE), ultralow density polyethylene (ULDPE), plastomer and elastomers. The term polyethylene also includes combinations of, or blends of, the polyethylenes described above.

The term “ethylene interpolymer” refers to a subset of polymers within the “ethylene polymer” group that excludes polymers produced in high pressure polymerization process; non-limiting examples of polymer produced in high pressure processes include LDPE and EVA (the latter is a copolymer of ethylene and vinyl acetate).

The term “heterogeneously branched ethylene interpolymer” refers to a subset of polymers in the ethylene interpolymer group that are produced using a heterogeneous catalyst system; non-limiting examples of which include Ziegler-Natta or chromium catalysts, both of which are well known in the art.

The term “homogeneously branched ethylene interpolymer” refers to a subset of polymers in the ethylene interpolymer group that are produced using single-site catalysts; non-limiting examples of which include metallocene catalysts, phosphinimine catalysts, and constrained geometry catalysts all of which are well known in the art.

Typically, homogeneously branched ethylene interpolymers have narrow molecular weight distributions, for example gel permeation chromatography (GPC) M_{w}/Mₙ values of less than about 2.8, especially less than about 2.3, although exceptions may arise; M_{w} and Mₙ refer to weight and number average molecular weights, respectively. In contrast, the M_{w}/Mₙ of heterogeneously branched ethylene interpolymers are typically greater than the M_{w}/Mₙ of homogeneous polyethylene. In general, homogeneously branched ethylene interpolymers also have a narrow composition distribution, i.e., each macromolecule within the molecular weight distribution has a similar comonomer content.

Frequently, the composition distribution breadth index “CDBI” is used to quantify how the comonomer is distributed within an ethylene interpolymer, as well as to differentiate ethylene interpolymers produced with different catalysts or processes. The “CDBI₅₀” is defined as the percent of ethylene interpolymer whose composition is within 50 weight percent (wt. %) of the median comonomer composition; this definition is consistent with that described in WO 93/03093 assigned to Exxon Chemical Patents Inc. The CDBI₅₀ of an ethylene interpolymer can be calculated from TREF curves (Temperature Rising Elution Fractionation); the TREF method is described in Wild, et al., J. Polym. Sci., Part B, Polym. Phys., Vol. 20 (3), pages 441-455. Typically, the CDBI₅₀ of homogeneously branched ethylene interpolymers are greater than about 70% or greater than about 75%. In contrast, the CDBI₅₀ of α-olefin containing heterogeneously branched ethylene interpolymers are generally lower than the CDBI₅₀ of homogeneous ethylene interpolymers. For example, the CDBI₅₀ of a heterogeneously branched ethylene interpolymer may be less than about 75%, or less than about 70%. A blend of two or more homogeneous ethylene interpolymers, that differ in comonomer content, may have a CDBI₅₀ less than 70%; in this disclosure such a blend was defined as a homogeneous blend or homogeneous composition.

Similarly, a blend of two or more homogeneous ethylene interpolymers, that differ in weight average molecular weight (M_{w}), may have a M_{w}/Mₙ of greater than or equal to 2.8; in this disclosure such a blend was defined as a homogeneous blend or homogeneous composition.

The term “thermoplastic” refers to a polymer that becomes liquid when heated, will flow under pressure and solidify when cooled. Thermoplastic polymers include ethylene polymers as well as other polymers used in the plastic industry; non-limiting examples of other polymers commonly used in film applications include barrier resins (EVOH), tie resins, polyethylene terephthalate (PET), polyamides and the like.

As used herein the term “monolayer film” refers to a film containing a single layer of one or more thermoplastics.

As used herein the term “multilayer film” or “multilayer film structure” refers to a film comprised of more than one thermoplastic layer, or optionally non-thermoplastic layers. Non-limiting examples of non-thermoplastic materials include metals (foil) or cellulosic (paper) products. One or more of the thermoplastic layers within a multilayer film (or film structure) may be comprised of more than one thermoplastic.

As used herein, the term “tie resin” refers to a thermoplastic that when formed into an intermediate layer, or a “tie layer” within a multilayer film structure, promotes adhesion between adjacent film layers that are dissimilar in chemical composition.

As used herein, the term “sealant layer” refers to a layer of thermoplastic film that is capable of being attached to a second substrate, forming a leak proof seal. A “sealant layer” may be a skin layer or the innermost layer in a multilayer film structure.

As used herein, the term “adhesive lamination” and the term “extrusion lamination” describes continuous processes through which two or more substrates, or webs of material, are combined to form a multilayer product or sheet; wherein the two or more webs are joined using an adhesive or a molten thermoplastic film, respectively.

As used herein, the term “extrusion coating” describes a continuous process through which a molten thermoplastic layer is combined with, or deposited on, a moving solid web or substrate. Non-limiting examples of substrates include paper, paperboard, foil, monolayer plastic film, multilayer plastic film or fabric. The molten thermoplastic layer could be monolayer or multilayer.

As used herein, the terms “hydrocarbyl”, “hydrocarbyl radical” or “hydrocarbyl group” refers to linear or cyclic, aliphatic, olefinic, acetylenic and aryl (aromatic) radicals comprising hydrogen and carbon that are deficient by one hydrogen.

As used herein, an “alkyl radical” includes linear, branched and cyclic paraffin radicals that are deficient by one hydrogen radical; non-limiting examples include methyl (—CH₃) and ethyl (—CH₂CH₃) radicals. The term “alkenyl radical” refers to linear, branched and cyclic hydrocarbons containing at least one carbon-carbon double bond that is deficient by one hydrogen radical.

As used herein, the term “aryl” group includes phenyl, naphthyl, pyridyl and other radicals whose molecules have an aromatic ring structure; non-limiting examples include naphthylene, phenanthrene and anthracene. An “arylalkyl” group is an alkyl group having an aryl group pendant there from; non-limiting examples include benzyl, phenethyl and tolylmethyl; an “alkylaryl” is an aryl group having one or more alkyl groups pendant there from; non-limiting examples include tolyl, xylyl, mesityl and cumyl.

As used herein, the phrase “heteroatom” includes any atom other than carbon and hydrogen that can be bound to carbon. A “heteroatom-containing group” is a hydrocarbon radical that contains a heteroatom and may contain one or more of the same or different heteroatoms. In one embodiment, a heteroatom-containing group is a hydrocarbyl group containing from 1 to 3 atoms selected from the group consisting of boron, aluminum, silicon, germanium, nitrogen, phosphorous, oxygen and sulfur. Non-limiting examples of heteroatom-containing groups include radicals of imines, amines, oxides, phosphines, ethers, ketones, oxoazolines heterocyclics, oxazolines, thioethers, and the like. The term “heterocyclic” refers to ring systems having a carbon backbone that comprise from 1 to 3 atoms selected from the group consisting of boron, aluminum, silicon, germanium, nitrogen, phosphorous, oxygen and sulfur.

As used herein the term “unsubstituted” means that hydrogen radicals are bounded to the molecular group that follows the term unsubstituted. The term “substituted” means that the group following this term possesses one or more moieties (non-hydrogen radicals) that have replaced one or more hydrogen radicals in any position within the group; non-limiting examples of moieties include halogen radicals (F, Cl, Br), hydroxyl groups, carbonyl groups, carboxyl groups, silyl groups, amine groups, phosphine groups, alkoxy groups, phenyl groups, naphthyl groups, C₁ to C₃₀ alkyl groups, C₂ to C₃₀ alkenyl groups, and combinations thereof. Non-limiting examples of substituted alkyls and aryls include: acyl radicals, alkyl silyl radicals, alkylamino radicals, alkoxy radicals, aryloxy radicals, alkylthio radicals, dialkylamino radicals, alkoxycarbonyl radicals, aryloxycarbonyl radicals, carbomoyl radicals, alkyl- and dialkyl-carbamoyl radicals, acyloxy radicals, acylamino radicals, arylamino radicals and combinations thereof.

### DESCRIPTION OF EMBODIMENTS

In the present disclosure, an ethylene interpolymer product will comprise an identifiable first fraction having a molecular weight distribution index M_{w}/Mₙ of from 1.8 to 4.0; and an identifiable second fraction having a molecular weight distribution index M_{w}/Mₙ of from 2.0 to 6.0. The weight percent and the molecular weight distribution index of the first fraction and the second fraction are obtained by deconvoluting an experimentally measured molecular weight distribution of the ethylene interpolymer product. Each of these fractions and the ethylene interpolymer product of which they are a part are further described below.

### The First Fraction

In some embodiments, the first fraction has a non-comonomer index distribution, NCIDᵢ¹, characterized by a first semi-log derivative, d NCIDᵢ¹/d log Mᵢ, which is greater than −0.0001, wherein the NCIDᵢ^{I} is obtained by deconvoluting an experimentally measured non-comonomer index of the ethylene interpolymer product.

In some embodiments, the first fraction has a non-comonomer index distribution, NCIDᵢ¹, characterized by a first semi-log derivative, d NCIDᵢ¹/d log Mᵢ, which has a value of zero, wherein the NCIDᵢ^{I} is obtained by deconvoluting an experimentally measured non-comonomer index of the ethylene interpolymer product.

In some embodiments, the first fraction has a first non-comonomer index distribution NCIDᵢ^{I} which satisfies the inequalities in eq.(1a′) and eq.(1b′) defined as follows:

$${NCID}_{i}^{1} > 1. - 0.00201 ( log {M}_{i} - log {M}_{o} + 4.93 ) + 0. 0137 {( log {M}_{i} - log {M}_{o} + 4.93 )}^{2} - 0.00034 {( log {M}_{i} - log {M}_{o} + 4.93 )}^{3} \qquad eq . ( 1 {a}^{′} )$$

$${NCID}_{i}^{1} < 0.73 - 0.00388 ( log {M}_{i} - log {M}_{o} + 4.93 ) + 0.00313 {( log {M}_{i} - log {M}_{o} + 4.93 )}^{2} - 0. 069 {( log {M}_{i} - log {M}_{o} + 4.93 )}^{3} \qquad eq . ( 1 {b}^{′} )$$

wherein Mₒ is a peak molecular weight that characterizes a molecular weight distribution of the first fraction when fit to a log-normal distribution and Mᵢ is an incremental molar mass that characterizes said molecular weight distribution, and wherein the NCIDᵢ¹ is obtained by deconvoluting an experimentally measured non-comonomer index of the ethylene interpolymer product.

In embodiments of the disclosure, the upper limit on the molecular weight distribution, M_{w}/Mₙ of the first fraction may be about 4.0, or about 3.8, or about 3.7, or about 3.6, or about 3.5. In embodiments of the disclosure, the lower limit on the molecular weight distribution, M_{w}/Mₙ of the first fraction may be about 1.6, or about 1.7, or about 1.8, or about 1.9.

In embodiments of the disclosure, the first fraction has a molecular weight distribution, M_{w}/Mₙ of ≤4.0, or <4.0, or <3.8, or <3.8, or <3.7, or <3.7, or about 3.7. In embodiments of the disclosure, the first fraction has a molecular weight distribution, M_{w}/Mₙ of from about 1.8 to about 4.0, or from about 1.9 to about 4.0 or from about 2.0 to about 4.0.

In an embodiment of the disclosure, the first fraction has a weight average molecular weight, M_{w} of from about 50 kg/mol to about 300 kg/mol, or from about 50 kg/mol to about 250 kg/mol, or from about 60 kg/mol to about 250 kg/mol, or from about 70 kg/mol to about 250 kg/mol, or from about 75 kg/mol to about 200 kg/mol, or from about 75 kg/mol to about 175 kg/mol; or from about 70 kg/mol to about 175 kg/mol, or from about 75 kg/mol to about 150 kg/mol.

In an embodiment of the disclosure, the first fraction has a weight average molecular weight, M_{w} which is greater than the weight average molecular weight, M_{w} of the second fraction.

In embodiments of the disclosure, the upper limit on the weight percent (wt. %) of the first fraction in the ethylene interpolymer product (i.e., the weight percent of the first fraction based on the total weight of the first and the second fraction) may be about 45 wt. %, or about 43 wt. %, or about 41 wt. %, or about 40 wt. %, or about 39 wt. %. In embodiments of the disclosure, the lower limit on the wt. % of the first fraction in the ethylene interpolymer product may be about 35 wt. %, or about 37 wt. %, or about 39 wt. %, or about 40 wt. %.

### The Second Fraction

The second fraction has a second non-comonomer index distribution, NCIDᵢ², having a value characterized by eq.(1a) and eq.(1b):

$${NCID}_{i}^{2} \leq 1.000 - 0.00201 ( log {M}_{i} - log {M}_{o} + 4.93 ) + 0. 0137 {( log {M}_{i} - log {M}_{o} + 4.93 )}^{2} - 0.00034 {( log {M}_{i} - log {M}_{o} + 4.93 )}^{3} \qquad eq . ( 1 a )$$

$${NCID}_{i}^{2} \geq 0.730 - 0.00388 ( log {M}_{i} - log {M}_{o} + 4.93 ) + 0.00313 {( log {M}_{i} - log {M}_{o} + 4.93 )}^{2} - 0. 069 {( log {M}_{i} - log {M}_{o} + 4.93 )}^{3} \qquad eq . ( 1 b )$$

wherein, Mₒ is a peak molecular weight that characterizes a molecular weight distribution of the second fraction when fit to a log-normal distribution and Mᵢ is an incremental molar mass that characterizes said molecular weight distribution; and wherein a first semi-log derivative of the NCIDᵢ², d(NCIDᵢ²)/d log Mᵢ, eq.(2),

$$d ( {NCID}_{i}^{2} ) / d log {M}_{i} = {β}_{1} + 2 {β}_{2} ( log {M}_{i} - log {M}_{o} + 4.93 ) + 3 {{β}_{3} ( log {M}_{i} - log {M}_{o} + 4.93 )}^{2} \qquad eq . ( 2 )$$

has a value of ≤−0.0001, coefficients β₀, β₁, β₂ and β₃ are generated by fitting the NCIDᵢ² to a third order polynomial, eq.(3),

$${NCID}_{i}^{2} = {β}_{0} + {β}_{1} ( log {M}_{i} - log {M}_{o} + 4.93 ) + {{β}_{2} ( log {M}_{i} - log {M}_{o} + 4.93 )}^{2} + {{β}_{3} ( log {M}_{i} - log {M}_{o} + 4.93 )}^{3} \qquad eq . ( 3 )$$

wherein the NCIDᵢ² is obtained by deconvoluting an experimentally measured non-comonomer index of the ethylene interpolymer product.

In embodiments of the disclosure, the second fraction has a molecular weight distribution, M_{w}/Mₙ of ≥2.0, or >2.0, or >2.1, or >2. 1, or >2.2, or >2.2, or >2.5, or >2.5, or >3.0, or 3.0. In embodiments of the disclosure, the second fraction has a molecular weight distribution, M_{w}/Mₙ of from 2.0 to 6.0, or from 2.0 to 5.5, or from 2.0 to 5.0, or from 2.1 to 4.5, or from 2.1 to 4.0, or from 2.1 to 3.5, or from 2.1 to 3.0, or from 2.1 to 2.9, or from 2.1 to 2.7, or from 2.1 to 2.5.

In an embodiment of the disclosure, the second fraction has a weight average molecular weight, M_{w} of from about 25 kg/mol to about 250 kg/mol, or from about 25 kg/mol to about 200 kg/mol, or from about 30 kg/mol to about 150 kg/mol, or from about 40 kg/mol to about 150 kg/mol, or from about 50 kg/mol to about 130 kg/mol, or from about 50 kg/mol to about 110 kg/mol.

In an embodiment of the disclosure, the second fraction has a weight average molecular weight, M_{w} which is less than the weight average molecular weight, M_{w} of the first fraction.

In embodiments of the disclosure, the upper limit on the weight percent (wt. %) of the second fraction in the ethylene interpolymer product (i.e., the weight percent of the second fraction based on the total weight of the first, and the second fractions) may be about 70 wt. %, or about 68 wt. %, or about 66 wt. %, or about 64 wt. %, or about 62 wt. %, or about 60 wt. %. In some embodiments of the disclosure, the lower limit on the wt. % of the second fraction in the ethylene copolymer composition is about 55 wt. %, or about 57 wt. %, or about 59 wt. %, or about 61 wt. %, or about 63 wt. %, or about 65 wt. %.

The Ethylene Interpolymer Product The ethylene interpolymer product disclosed herein can be made using any well-known techniques in the art.

In an embodiment, the ethylene interpolymer product of the present disclosure is made by forming a first ethylene interpolymer in a first reactor; and forming a second ethylene interpolymer in a second reactor.

In an embodiment, the ethylene interpolymer product of the present disclosure is made by forming a first ethylene interpolymer in a first reactor; forming a second ethylene interpolymer in a second; and forming a third ethylene interpolymer in a third reactor.

In an embodiment, the ethylene interpolymer product of the present disclosure is made by forming a first ethylene interpolymer in a first reactor by polymerizing ethylene and an α-olefin with a single site catalyst; and forming a second ethylene interpolymer in a second reactor by polymerizing ethylene and an α-olefin with a multi-site catalyst.

In an embodiment, the ethylene interpolymer product of the present disclosure is made by forming a first ethylene interpolymer in a first reactor by polymerizing ethylene and an α-olefin with a single site catalyst; forming a second ethylene interpolymer in a second reactor by polymerizing ethylene and an α-olefin with a multi-site catalyst and forming a third ethylene interpolymer in a third reactor by polymerizing ethylene and an α-olefin with a multi-site catalyst.

In an embodiment, the ethylene interpolymer product of the present disclosure is made by forming a first ethylene interpolymer in a first reactor by polymerizing ethylene and an α-olefin with a single site catalyst; forming a second ethylene interpolymer in a second reactor by polymerizing ethylene and an α-olefin with a multi-site catalyst and forming a third ethylene interpolymer in a third reactor by polymerizing ethylene and an α-olefin with a single site catalyst.

In an embodiment, the ethylene interpolymer product of the present disclosure is made by forming a first ethylene interpolymer in a first solution phase polymerization reactor by polymerizing ethylene and an α-olefin with a single site catalyst; and forming a second ethylene interpolymer in a second solution phase polymerization reactor by polymerizing ethylene and an α-olefin with a multi-site catalyst.

In an embodiment, the ethylene interpolymer product of the present disclosure is made by forming a first ethylene interpolymer in a first solution phase polymerization reactor by polymerizing ethylene and an α-olefin with a single site catalyst; forming a second ethylene interpolymer in a second solution phase polymerization reactor by polymerizing ethylene and an α-olefin with a multi-site catalyst, and forming a third ethylene interpolymer in a third solution phase polymerization reactor by polymerizing ethylene and an α-olefin with a multi-site catalyst.

In an embodiment, the ethylene interpolymer product of the present disclosure is made by forming a first ethylene interpolymer in a first solution phase polymerization reactor by polymerizing ethylene and an α-olefin with a single site catalyst; forming a second ethylene interpolymer in a second solution phase polymerization reactor by polymerizing ethylene and an α-olefin with a multi-site catalyst, and forming a third ethylene interpolymer in a third solution phase polymerization reactor by polymerizing ethylene and an α-olefin with a single site catalyst.

In an embodiment, the ethylene interpolymer product of the present disclosure is made by forming a first ethylene interpolymer in a first solution phase polymerization reactor by polymerizing ethylene and an α-olefin with a single site catalyst; and forming a second ethylene interpolymer in a second solution phase polymerization reactor by polymerizing ethylene and an α-olefin with a multi-site catalyst, where the first and second solution phase polymerization reactors are configured in series with one another.

In an embodiment, the ethylene interpolymer product of the present disclosure is made by forming a first ethylene interpolymer in a first solution phase polymerization reactor by polymerizing ethylene and an α-olefin with a single site catalyst; and forming a second ethylene interpolymer in a second solution phase polymerization reactor by polymerizing ethylene and an α-olefin with a multi-site catalyst, where the first and second solution phase polymerization reactors are configured in parallel with one another.

In an embodiment, the ethylene interpolymer product of the present disclosure is made by forming a first ethylene interpolymer in a first solution phase polymerization reactor by polymerizing ethylene and an α-olefin with a single site catalyst; forming a second ethylene interpolymer in a second solution phase polymerization reactor by polymerizing ethylene and an α-olefin with a multi-site catalyst, and forming a third ethylene interpolymer in a third solution phase polymerization reactor by polymerizing ethylene and an α-olefin with a multi-site catalyst, where the first and second solution phase polymerization reactors are configured in series with one another.

In an embodiment, the ethylene interpolymer product of the present disclosure is made by forming a first ethylene interpolymer in a first solution phase polymerization reactor by polymerizing ethylene and an α-olefin with a single site catalyst; forming a second ethylene interpolymer in a second solution phase polymerization reactor by polymerizing ethylene and an α-olefin with a multi-site catalyst, and forming a third ethylene interpolymer in a third solution phase polymerization reactor by polymerizing ethylene and an α-olefin with a multi-site catalyst, where at least the first and second solution phase polymerization reactors are configured in series with one another.

In an embodiment, the ethylene interpolymer product of the present disclosure is made by forming a first ethylene interpolymer in a first solution phase polymerization reactor by polymerizing ethylene and an α-olefin with a single site catalyst; forming a second ethylene interpolymer in a second solution phase polymerization reactor by polymerizing ethylene and an α-olefin with a multi-site catalyst, and forming a third ethylene interpolymer in a third solution phase polymerization reactor by polymerizing ethylene and an alpha olefin with a multi-site catalyst, where the first, second and third solution phase polymerization reactors are configured in series with one another.

In an embodiment, the ethylene interpolymer product of the present disclosure is made by forming a first ethylene interpolymer in a first solution phase polymerization reactor by polymerizing ethylene and an α-olefin with a single site catalyst; forming a second ethylene interpolymer in a second solution phase polymerization reactor by polymerizing ethylene and an α-olefin with a multi-site catalyst, and forming a third ethylene interpolymer in a third solution phase polymerization reactor by polymerizing ethylene and an α-olefin with a multi-site catalyst, where each of the first, second and third solution phase polymerization reactors are configured in parallel to one another.

In an embodiment, the ethylene interpolymer product of the present disclosure is made by forming a first ethylene interpolymer in a first solution phase polymerization reactor by polymerizing ethylene and an α-olefin with a single site catalyst; forming a second ethylene interpolymer in a second solution phase polymerization reactor by polymerizing ethylene and an α-olefin with a multi-site catalyst, and forming a third ethylene interpolymer in a third solution phase polymerization reactor by polymerizing ethylene and an α-olefin with a multi-site catalyst, where the first and second solution phase reactors are configured in series to one another, and the third solution phase reactor is configured in parallel to the first and second reactors.

In an embodiment, the ethylene interpolymer product of the present disclosure is made by forming a first ethylene interpolymer in a first solution phase polymerization reactor by polymerizing ethylene and an α-olefin with a single site catalyst; forming a second ethylene interpolymer in a second solution phase polymerization reactor by polymerizing ethylene and an α-olefin with a multi-site catalyst, and forming a third ethylene interpolymer in a third solution phase polymerization reactor by polymerizing ethylene and an α-olefin with a single site catalyst, where at least the first and second solution phase polymerization reactors are configured in series with one another.

In an embodiment, the ethylene interpolymer product of the present disclosure is made by forming a first ethylene interpolymer in a first solution phase polymerization reactor by polymerizing ethylene and an α-olefin with a single site catalyst; forming a second ethylene interpolymer in a second solution phase polymerization reactor by polymerizing ethylene and an α-olefin with a multi-site catalyst, and forming a third ethylene interpolymer in a third solution phase polymerization reactor by polymerizing ethylene and an α-olefin with a single site catalyst, where the first, second and third solution phase polymerization reactors are configured in series with one another.

In an embodiment, the ethylene interpolymer product of the present disclosure is made by forming a first ethylene interpolymer in a first solution phase polymerization reactor by polymerizing ethylene and an α-olefin with a single site catalyst; forming a second ethylene interpolymer in a second solution phase polymerization reactor by polymerizing ethylene and an α-olefin with a multi-site catalyst, and forming a third ethylene interpolymer in a third solution phase polymerization reactor by polymerizing ethylene and an α-olefin with a single site catalyst, where each of the first, second and third solution phase polymerization reactors are configured in parallel to one another.

In an embodiment, the ethylene interpolymer product of the present disclosure is made by forming a first ethylene interpolymer in a first solution phase polymerization reactor by polymerizing ethylene and an α-olefin with a single site catalyst; forming a second ethylene interpolymer in a second solution phase polymerization reactor by polymerizing ethylene and an α-olefin with a multi-site catalyst, and forming a third ethylene interpolymer in a third solution phase polymerization reactor by polymerizing ethylene and an α-olefin with a single site catalyst, where the first and second solution phase reactors are configured in series to one another, and the third solution phase reactor is configured in parallel to the first and second reactors.

In an embodiment, the solution phase polymerization reactor used as a first solution phase reactor, a second solution phase reactor, or a third solution phase reactor is a continuously stirred tank reactor or a tubular reactor.

In an embodiment, the solution phase polymerization reactor used as a first solution phase reactor, a second solution phase reactor, or a third solution phase reactor is a continuously stirred tank reactor.

In an embodiment, the solution phase polymerization reactor used as a first solution phase reactor, a second solution phase reactor, or a third solution phase reactor is a tubular reactor.

In an embodiment, the solution phase polymerization reactor used as a first solution phase reactor and a second solution phase reactor is a continuously stirred tank reactor, and the solution phase polymerization reactor used as a third solution phase reactor is a tubular reactor.

In an embodiment of the disclosure, the single site catalyst has hafnium, Hf as the active metal center.

In an embodiment of the disclosure, the single site catalyst is a metallocene catalyst.

In an embodiment of the disclosure, the single site catalyst is a bridged metallocene catalyst.

In an embodiment of the disclosure, the single site catalyst is a bridged metallocene catalyst having the formula I:

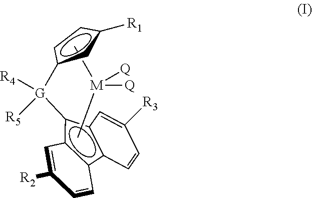

In Formula (I): M is a group 4 metal selected from titanium, zirconium or hafnium; G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁-20 hydrocarbyl radical, a C₁₋₂₀ alkoxy radical or a C₆₋₁₀ aryl oxide radical; and Q is independently an activatable leaving group ligand.

In an embodiment, R₄ and R₅ are independently an aryl group. In an embodiment, R₄ and R₅ are independently a phenyl group or a substituted phenyl group. In an embodiment, R₄ and R₅ are a phenyl group. In an embodiment, R₄ and R₅ are independently a substituted phenyl group. In an embodiment, R₄ and R₅ are a substituted phenyl group, wherein the phenyl group is substituted with a substituted silyl group. In an embodiment, R₄ and R₅ are a substituted phenyl group, wherein the phenyl group is substituted with a trialkyl silyl group.

In an embodiment, R₄ and R₅ are a substituted phenyl group, wherein the phenyl group is substituted at the para position with a trialkylsilyl group. In an embodiment, R¹ and R² are a substituted phenyl group, wherein the phenyl group is substituted at the para position with a trimethylsilyl group. In an embodiment, R¹ and R² are a substituted phenyl group, wherein the phenyl group is substituted at the para position with a triethylsilyl group.

In an embodiment, R₄ and R₅ are independently an alkyl group. In an embodiment, R₄ and R₅ are independently an alkenyl group. In an embodiment, R₁ is hydrogen. In an embodiment, R₁ is an alkyl group. In an embodiment, R₁ is an aryl group. In an embodiment, R₁ is an alkenyl group. In an embodiment, R₂ and R₃ are independently a hydrocarbyl group having from 1 to 30 carbon atoms. In an embodiment, R₂ and R₃ are independently an aryl group. In an embodiment, R₂ and R₃ are independently an alkyl group. In an embodiment, R₂ and R₃ are independently an alkyl group having from 1 to 20 carbon atoms. In an embodiment, R₂ and R₃ are independently a phenyl group or a substituted phenyl group. In an embodiment, R₂ and R₃ are a tert-butyl group. In an embodiment, R₂ and R₃ are hydrogen.

In an embodiment of the disclosure, the single site catalyst is a bridged metallocene catalyst having the formula II:

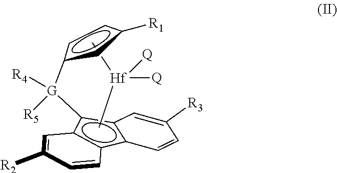

In Formula (II): G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

In the current disclosure, the term “activatable” means that the ligand Q may be cleaved from the metal center M via a protonolysis reaction or abstracted from the metal center M by suitable acidic or electrophilic catalyst activator compounds (also known as “co-catalyst” compounds) respectively, examples of which are described below. The activatable ligand Q may also be transformed into another ligand which is cleaved or abstracted from the metal center M (e.g., a halide may be converted to an alkyl group).

Without wishing to be bound by any single theory, protonolysis or abstraction reactions generate an active “cationic” metal center which can polymerize olefins.

In embodiments of the present disclosure, the activatable ligand, Q is independently selected from the group consisting of a hydrogen atom; a halogen atom; a C₁₋₂₀ hydrocarbyl radical, a C₁₋₂₀ alkoxy radical, and a C₆₋₁₀ aryl or aryloxy radical, where each of the hydrocarbyl, alkoxy, aryl, or aryl oxide radicals may be un-substituted or further substituted by one or more halogen or other group; a C₁₋₈ alkyl; a C₁₋₈ alkoxy; a C₆₋₁₀ aryl or aryloxy; an amido or a phosphido radical, but where Q is not a cyclopentadienyl. Two Q ligands may also be joined to one another and form for example, a substituted or unsubstituted diene ligand (e.g., 1,3-butadiene); or a delocalized heteroatom containing group such as an acetate or acetamidinate group. In a convenient embodiment of the disclosure, each Q is independently selected from the group consisting of a halide atom, a C₁₋₄ alkyl radical and a benzyl radical. Particularly suitable activatable ligands Q are monoanionic such as a halide (e.g., chloride) or a hydrocarbyl (e.g., methyl, benzyl).

In an embodiment of the disclosure, the single site catalyst is diphenylmethylene(cyclopentadienyl)(2,7-di-t-butylfuorenyl)hafnium dichloride having the molecular formula: [(2,7-tBu₂Flu)Ph₂C(Cp)HfCl₂].

In an embodiment of the disclosure, the single site catalyst is diphenylmethylene(cyclopentadienyl)(2,7-di-t-butylfuorenyl)hafnium dimethyl having the molecular formula: [(2,7-tBu₂Flu)Ph₂C(Cp)HfMe₂].

In addition to the single site catalyst molecule per se, an active single site catalyst system may further comprise one or more of the following: an alkylaluminoxane co-catalyst and an ionic activator. The single site catalyst system may also optionally comprise a hindered phenol.

Although the exact structure of alkylaluminoxane is uncertain, subject matter experts generally agree that it is an oligomeric species that contain repeating units of the general formula:

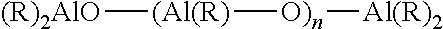

where the R groups may be the same or different linear, branched or cyclic hydrocarbyl radicals containing 1 to 20 carbon atoms and n is from 0 to about 50. A non-limiting example of an alkylaluminoxane is methylaluminoxane (or MAO) wherein each R group is a methyl radical. In an embodiment of the disclosure, R of the alkylaluminoxane, is a methyl radical and m is from 10 to 40.

In an embodiment of the disclosure, the co-catalyst is modified methylaluminoxane (MMAO). It is well known in the art, that the alkylaluminoxane can serve dual roles as both an alkylator and an activator. Hence, an alkylaluminoxane co-catalyst is often used in combination with activatable ligands such as halogens.

In general, ionic activators are comprised of a cation and a bulky anion; wherein the latter is substantially non-coordinating. Non-limiting examples of ionic activators are boron ionic activators that are four coordinate with four ligands bonded to the boron atom. Non-limiting examples of boron ionic activators include the following formulas shown below:

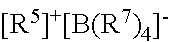

where B represents a boron atom, R⁵ is an aromatic hydrocarbyl (e.g. triphenyl methyl cation) and each R⁷ is independently selected from phenyl radicals which are unsubstituted or substituted with from 3 to 5 substituents selected from fluorine atoms, C₁₋₄ alkyl or alkoxy radicals which are unsubstituted or substituted by fluorine atoms; and a silyl radical of formula —Si(R⁹)₃, where each R⁹ is independently selected from hydrogen atoms and C₁_4 alkyl radicals, and

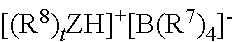

where B is a boron atom, H is a hydrogen atom, Z is a nitrogen or phosphorus atom, t is 2 or 3 and R⁸ is selected from C₁₋₈ alkyl radicals, phenyl radicals which are unsubstituted or substituted by up to three C₁₋₄ alkyl radicals, or one R⁸ taken together with the nitrogen atom may form an anilinium radical and R⁷ is as defined above.

In both formula a non-limiting example of R⁷ is a pentafluorophenyl radical. In general, boron ionic activators may be described as salts of tetra(perfluorophenyl) boron; non-limiting examples include anilinium, carbonium, oxonium, phosphonium and sulfonium salts of tetra(perfluorophenyl)boron with anilinium and trityl (or triphenylmethylium). Additional non-limiting examples of ionic activators include: triethylammonium tetra(phenyl)boron, tripropylammonium tetra(phenyl)boron, tri(n-butyl)ammonium tetra(phenyl)boron, trimethylammonium tetra(p-tolyl)boron, trimethylammonium tetra(o-tolyl)boron, tributylammonium tetra(pentafluorophenyl)boron, tripropylammonium tetra(o,p-dimethylphenyl)boron, tributylammonium tetra(m,m-dimethylphenyl)boron, tributylammonium tetra(p-trifluoromethylphenyl)boron, tributylammonium tetra(pentafluorophenyl)boron, tri(n-butyl)ammonium tetra(o-tolyl)boron, N,N-dimethylanilinium tetra(phenyl)boron, N,N-diethylanilinium tetra(phenyl)boron, N,N-diethylanilinium tetra(phenyl)n-butylboron, N,N-2,4,6-pentamethylanilinium tetra(phenyl)boron, di-(isopropyl)ammonium tetra(pentafluorophenyl)boron, dicyclohexylammonium tetra(phenyl)boron, triphenylphosphonium tetra(phenyl)boron, tri(methylphenyl)phosphonium tetra(phenyl)boron, tri(dimethylphenyl)phosphonium tetra(phenyl)boron, tropillium tetrakispentafluorophenyl borate, triphenylmethylium tetrakispentafluorophenyl borate, benzene(diazonium)tetrakispentafluorophenyl borate, tropillium tetrakis(2,3,5,6-tetrafluorophenyl)borate, triphenylmethylium tetrakis(2,3,5,6-tetrafluorophenyl)borate, benzene(diazonium)tetrakis(3,4,5-trifluorophenyl)borate, tropillium tetrakis(3,4,5-trifluorophenyl)borate, benzene(diazonium)tetrakis(3,4,5-trifluorophenyl)borate, tropillium tetrakis(1,2,2-trifluoroethenyl)borate, triphenylmethylium tetrakis(1,2,2-trifluoroethenyl)borate, benzene(diazonium)tetrakis(1,2,2-trifluoroethenyl)borate, tropillium tetrakis(2,3,4,5-tetrafluorophenyl)borate, triphenylmethylium tetrakis(2,3,4,5-tetrafluorophenyl)borate, and benzene(diazonium)tetrakis(2,3,4,5 tetrafluorophenyl)borate. Readily available commercial ionic activators include N,N-dimethylanilinium tetrakispentafluorophenyl borate, and triphenylmethylium tetrakispentafluorophenyl borate.

Non-limiting example of hindered phenols include butylated phenolic antioxidants, butylated hydroxytoluene, 2,6-di-tertiarybutyl-4-ethyl phenol, 4,4′-methylenebis (2,6-di-tertiary-butylphenol), 1,3, 5-trimethyl-2,4,6-tris (3,5-di-tert-butyl-4-hydroxybenzyl)benzene and octadecyl-3-(3′,5′-di-tert-butyl-4′-hydroxyphenyl) propionate.

To produce an active single site catalyst system the quantity and mole ratios of the three or four components: the single site catalyst, the alkylaluminoxane, the ionic activator, and the optional hindered phenol are optimized.

In an embodiment, the multi-site catalyst is an in-line Ziegler-Natta catalyst system or a batch Ziegler-Natta catalyst system.

The term “in-line Ziegler-Natta catalyst system” refers to the continuous synthesis of a small quantity of an active Ziegler-Natta catalyst system and immediately injecting this catalyst into at least one continuously operating reactor, wherein the catalyst polymerizes ethylene and one or more optional α-olefins to form an ethylene polymer. The terms “batch Ziegler-Natta catalyst system” or “batch Ziegler-Natta procatalyst” refer to the synthesis of a much larger quantity of catalyst or procatalyst in one or more mixing vessels that are external to, or isolated from, the continuously operating solution polymerization process.

Once prepared, the batch Ziegler-Natta catalyst system, or batch Ziegler-Natta procatalyst, is transferred to a catalyst storage tank. The term “procatalyst” refers to an inactive catalyst system (inactive with respect to ethylene polymerization); the procatalyst is converted into an active catalyst by adding an alkyl aluminum co-catalyst. As needed, the procatalyst is pumped from the storage tank to at least one continuously operating reactor, wherein an active catalyst polymerizes ethylene and one or more optional α-olefins to form an ethylene interpolymer. The procatalyst may be converted into an active catalyst in the reactor or external to the reactor, or on route to the reactor.

A non-limiting example of an active in-line (or batch) Ziegler-Natta catalyst system to make the second ethylene interpolymer can be prepared as follows. In the first step, a solution of a magnesium compound is reacted with a solution of a chloride compound to form a magnesium chloride support suspended in solution. Non-limiting examples of magnesium compounds include Mg(R¹)₂; wherein the R¹ groups may be the same or different, linear, branched or cyclic hydrocarbyl radicals containing 1 to 10 carbon atoms. Non-limiting examples of chloride compounds include R²Cl; wherein R² represents a hydrogen atom, or a linear, branched or cyclic hydrocarbyl radical containing 1 to 10 carbon atoms. In the first step, the solution of magnesium compound may also contain an aluminum alkyl. Non-limiting examples of aluminum alkyl include Al(R³)₃, wherein the R³ groups may be the same or different, linear, branched or cyclic hydrocarbyl radicals containing from 1 to 10 carbon atoms. In the second step a solution of the metal compound is added to the solution of magnesium chloride and the metal compound is supported on the magnesium chloride. Non-limiting examples of suitable metal compounds include M(X). or MO(X)n; where M represents a metal selected from Group 4 through Group 8 of the Periodic Table, or mixtures of metals selected from Group 4 through Group 8; O represents oxygen; and X represents chloride or bromide; n is an integer from 3 to 6 that satisfies the oxidation state of the metal. Additional non-limiting examples of suitable metal compounds include Group 4 to Group 8 metal alkyls, metal alkoxides (which may be prepared by reacting a metal alkyl with an alcohol) and mixed-ligand metal compounds that contain a mixture of halide, alkyl and alkoxide ligands. In the third step a solution of an alkyl aluminum co-catalyst is added to the metal compound supported on the magnesium chloride. A wide variety of alkyl aluminum co-catalysts are suitable, as expressed by formula:

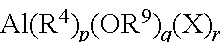

wherein the R⁴ groups may be the same or different, hydrocarbyl groups having from 1 to 10 carbon atoms; the OR⁹ groups may be the same or different, alkoxy or aryloxy groups wherein R⁹ is a hydrocarbyl group having from 1 to 10 carbon atoms bonded to oxygen; X is chloride or bromide; and (p+q+r)=3, with the proviso that p is greater than 0. Non-limiting examples of commonly used alkyl aluminum co-catalysts include trimethyl aluminum, triethyl aluminum, tributyl aluminum, dimethyl aluminum methoxide, diethyl aluminum ethoxide, dibutyl aluminum butoxide, dimethyl aluminum chloride or bromide, diethyl aluminum chloride or bromide, dibutyl aluminum chloride or bromide and ethyl aluminum dichloride or dibromide.

The process described in the paragraph above, to synthesize an active in-line (or batch) Ziegler-Natta catalyst system, can be carried out in a variety of solvents; non-limiting examples of solvents include linear or branched C₅ to C₁2 alkanes or mixtures thereof.

In solution polymerization, the monomers are dissolved/dispersed in the solvent either prior to being fed to the reactor (or for gaseous monomers the monomer may be fed to the reactor so that it will dissolve in the reaction mixture). Prior to mixing, the solvent and monomers are generally purified to remove potential catalyst poisons such as water, oxygen or metal impurities. The feedstock purification follows standard practices in the art, e.g., molecular sieves, alumina beds and oxygen removal catalysts are used for the purification of monomers. The solvent itself as well (e.g., methyl pentane, cyclohexane, hexane or toluene) is preferably treated in a similar manner.

The feedstock may be heated or cooled prior to feeding to the reactor.

Generally, the catalyst components may be premixed in the solvent for the reaction or fed as separate streams to the reactor. In some instances, premixing it may be desirable to provide a reaction time for the catalyst components prior to entering the reaction. Such an “in line mixing” technique is described in a number of patents in the name of DuPont Canada Inc. (e.g. U.S. Pat. No. 5,589,555 issued Dec. 31, 1996).

Solution polymerization processes for the polymerization or copolymerization of ethylene are well known in the art (see for example U.S. Pat. Nos. 6,372,864 and 6,777,509).

These processes are conducted in the presence of an inert hydrocarbon solvent. In a solution phase polymerization reactor, a variety of solvents may be used as the process solvent; non-limiting examples include linear, branched or cyclic C₅ to C₁₂ alkanes. Non-limiting examples of α-olefins include 1-propene, 1-butene, 1-pentene, 1-hexene and 1-octene. Suitable catalyst component solvents include aliphatic and aromatic hydrocarbons. Non-limiting examples of aliphatic catalyst component solvents include linear, branched or cyclic C₅₋₁₂ aliphatic hydrocarbons, e.g. pentane, methyl pentane, hexane, heptane, octane, cyclohexane, cyclopentane, methylcyclohexane, hydrogenated naphtha or combinations thereof. Non-limiting examples of aromatic catalyst component solvents include benzene, toluene (methylbenzene), ethylbenzene, o-xylene (1,2-dimethylbenzene), m-xylene (1,3-dimethylbenzene), p-xylene (1,4-dimethylbenzene), mixtures of xylene isomers, hemellitene (1,2,3-trimethylbenzene), pseudocumene (1,2,4-trimethylbenzene), mesitylene (1,3,5-trimethylbenzene), mixtures of trimethylbenzene isomers, prehenitene (1,2,3,4-tetramethylbenzene), durene (1,2,3,5-tetramethylbenzene), mixtures of tetramethylbenzene isomers, pentamethylbenzene, hexamethylbenzene and combinations thereof.

The polymerization temperature in a conventional solution process may be from about 80° C. to about 300° C. In an embodiment of the disclosure the polymerization temperature in a solution process is from about 120° C. to about 250° C. The polymerization pressure in a solution process may be a “medium pressure process”, meaning that the pressure in the reactor is less than about 6,000 psi (about 42,000 kiloPascals or kPa). In an embodiment of the disclosure, the polymerization pressure in a solution process may be from about 10,000 to about 40,000 kPa, or from about 14,000 to about 22,000 kPa (i.e. from about 2,000 psi to about 3,000 psi).

Suitable monomers for copolymerization with ethylene include C₃₋₂₀ mono- and di-olefins. Preferred comonomers include C₃₋₁2 alpha olefins which are unsubstituted or substituted by up to two C₁₋₆ alkyl radicals, C₈₋₁2 vinyl aromatic monomers which are unsubstituted or substituted by up to two substituents selected from the group consisting of C₁₋₄ alkyl radicals, C₄₋₁₂ straight chained or cyclic diolefins which are unsubstituted or substituted by a C₁₋₄ alkyl radical. Illustrative non-limiting examples of such alpha-olefins are one or more of propylene, 1-butene, 1-pentene, 1-hexene, 1-octene and 1-decene, styrene, alpha methyl styrene, and the constrained-ring cyclic olefins such as cyclobutene, cyclopentene, dicyclopentadiene norbornene, alkyl-substituted norbornenes, alkenyl-substituted norbornenes and the like (e.g., 5-methylene-2-norbornene and 5-ethylidene-2-norbornene, bicyclo-(2,2,1)-hepta-2,5-diene).

In an embodiment of the disclosure, the ethylene interpolymer product has at least 1 mole percent of one or more than one α-olefin.

In an embodiment of the disclosure, the ethylene interpolymer product has at least 3 mole percent of one or more than one α-olefin.

In an embodiment of the disclosure, the ethylene interpolymer product has from about 1 to about 10 mole percent of one or more than one α-olefin.

In an embodiment of the disclosure, the ethylene interpolymer product has from about 3 to about 10 mole percent of one or more than one α-olefin.

In an embodiment of the disclosure, the ethylene interpolymer product has from about 3 to about 8 mole percent of one or more than one α-olefin.

In an embodiment of the disclosure, the ethylene interpolymer product comprises ethylene and one or more than one α-olefin selected from the group comprising 1-butene, 1-hexene, 1-octene and mixtures thereof.

In an embodiment of the disclosure, the ethylene interpolymer product comprises ethylene and one or more than one alpha olefin selected from the group comprising 1-hexene, 1-octene and mixtures thereof.

In an embodiment of the disclosure, the ethylene interpolymer product comprises ethylene and 1-octene.

In an embodiment of the disclosure, the ethylene interpolymer product comprises ethylene and at least 1 mole percent 1-octene.

In an embodiment of the disclosure, the ethylene interpolymer product comprises ethylene and from 1 to 10 mole percent of 1-octene.

In an embodiment of the disclosure, the ethylene interpolymer product comprises ethylene and from 3 to 8 mole percent of 1-octene.

In embodiments of the disclosure, the ethylene interpolymer product has a density which may be from about 0.900 g/cm³ to about 0.940 g/cm³, or from about 0.905 g/cm³ to about 0.935 g/cm³, or from about 0.908 g/cm³ to 0.932 g/cm³, or from about 0.910 g/cm³ to about 0.930 g/cm³, or from about 0.912 g/cm³ to about 0.925 g/cm³, or from about 0.913 g/cm³ to about 0.925 g/cm³, or from about 0.913 g/cm³ to about 0.923 g/cm³, or from about 0.913 g/cm³ to about 0.9225 g/cm³, or from about 0.913 g/cm³ to about 0.920 g/cm³, or from about 0.917 g/cm³ to about 0.920 g/cm³, or from about 0.917 g/cm³ to about 0.919 g/cm³, or from about 0.9115 g/cm³ to about 0.9145 g/cm³, or from about 0.9130 g/cm³ to about 0.9160 g/cm³.

In embodiments of the disclosure the melt index, 12 of the ethylene interpolymer product may be from about 0.1 dg/min to about 10.0 dg/min, or from about 0.1 dg/min to about 5.0 dg/min, or from about 0.2 dg/min to about 5.0 dg/min, or from about 0.3 dg/min to about 2.0 dg/min, or from about 0.4 dg/min to about 2.0 dg/min, or from about 0.45 dg/min to about 2.0 dg/min, or from about 0.5 dg/min to about 1.5 dg/min, or from about 0.6 dg/min to about 1.5 dg/min, or from about 0.7 dg/min to about 1.0 dg/min, or from about 0.72 dg/min to about 1.0 dg/min, or less than about 2 dg/min, or less than about 1.5 dg/min, or less than about 1.0 dg/min.

In embodiments of the disclosure the high load melt index, 121 of the ethylene interpolymer product may be from about 10 dg/min to about 10,000 dg/min, or from about 10 dg/min to about 1,000 dg/min, or from about 10 dg/min to about 500 dg/min, or from about 10 dg/min to about 250 dg/min, or from about 10 dg/min to about 150 dg/min, or from about 10 dg/min to about 100 dg/min.

In embodiments of the disclosure the melt flow ratio I₂₁/I₂ of the ethylene interpolymer product may be from about 15 to about 100, or from about 15 to about 75, or from about 15 to about 50, or from about 15 to about 40, or from about 18 to about 50, or from about 20 to about 75, or from about 20 to about 50, or from about 20 to about 45, or from about 20 to about 40, or from about 20 to about 38, or from about 20 to about 35, or less than about 45, or less than about 40, or less than about 38.

In embodiments of the disclosure, the ethylene interpolymer product has a weight average molecular weight, M_{w} of from about 40 kg/mol to about 300 kg/mol, or from about 40 kg/mol to about 250 kg/mol, or from about 50 kg/mol to about 250 kg/mol, or from about 50 kg/mol to about 225 kg/mol, or from about 50 kg/mol to about 200 kg/mol, or from about 50 kg/mol to about 175 kg/mol, or from about 50 kg/mol to about 150 kg/mol, or from about 50 kg/mol to about 125 kg/mol.

In embodiments of the disclosure, the ethylene interpolymer product has a lower limit molecular weight distribution, M_{w}/Mₙ of 2.0, or 2.1, or 2.2, or 2.3. In embodiments of the disclosure, the ethylene interpolymer product has an upper limit molecular weight distribution, M_{w}/Mₙ of 6.0, or 5.5, or 5.0, or 4.5, or 4.0, or 3.75, or 3.5.

In embodiments of the disclosure, the ethylene interpolymer product has a molecular weight distribution, M_{w}/Mₙ of from 2.1 to 6.0, or from 2.1 to 5.5, or from 2.3 to 5.0, or from 2.5 to 5.0, or from 2.1 to 4.0, or from 2.1 to 4.0, or from 2.2 to 4.0, or from 2.5 to 4.0, or from 2.2 to 5.0, or from 2.2 to 4.5, or from 2.2 to 4.0, or from 2.2 to 3.5, or from 2.2 to 3.0.

In embodiments of the disclosure, the ethylene interpolymer product has a z-average molecular weight distribution, M_{z}/M_{w} of ≤4.0, or <4.0, or <3.5, or <3.5, or <3.0, or <3.0, or <2.75, or <2.75, or <2.50, or <2.50. In embodiments of the disclosure, the polyethylene composition has a z-average molecular weight distribution, M_{z}/M_{w} of from 1.5 to 4.0, or from 1.75 to 3.5, or from 1.75 to 3.0, or from 2.0 to 4.0, or from 2.0 to 3.5, or from 2.0 to 3.0, or from 2.0 to 2.75.

In an embodiment of the disclosure, the ethylene interpolymer product has a unimodal profile in a gel permeation chromatograph generated according to the method of ASTM D6474-99. The term “unimodal” is herein defined to mean there will be only one significant peak or maximum evident in the GPC-curve. A unimodal profile includes a broad unimodal profile. In contrast, the use of the term “bimodal” is meant to convey that in addition to a first peak, there will be a secondary peak or shoulder which represents a higher or lower molecular weight component (i.e., the molecular weight distribution, can be said to have two maxima in a molecular weight distribution curve). Alternatively, the term “bimodal” connotes the presence of two maxima in a molecular weight distribution curve generated according to the method of ASTM D6474-99. The term “multi-modal” denotes the presence of two or more, typically more than two, maxima in a molecular weight distribution curve generated according to the method of ASTM D6474-99.

In an embodiment of the disclosure, the ethylene interpolymer product will have a reverse or partially reverse comonomer distribution profile as measured using GPC-FTIR. If the comonomer incorporation decreases with molecular weight, as measured using GPC-FTIR, the distribution is described as “normal”. If the comonomer incorporation is approximately constant with molecular weight, as measured using GPC-FTIR, the comonomer distribution is described as “flat” or “uniform”. The terms “reverse comonomer distribution” and “partially reverse comonomer distribution” mean that in the GPC-FTIR data obtained for a copolymer, there is one or more higher molecular weight components having a higher comonomer incorporation than in one or more lower molecular weight components. The term “reverse(d) comonomer distribution” is used herein to mean, that across the molecular weight range of an ethylene interpolymer, comonomer contents for the various polymer fractions are not substantially uniform and the higher molecular weight fractions thereof have proportionally higher comonomer contents (i.e., if the comonomer incorporation rises with molecular weight, the distribution is described as “reverse” or “reversed”). Where the comonomer incorporation rises with increasing molecular weight and then declines, the comonomer distribution is still considered “reverse”, but may also be described as “partially reverse”. A partially reverse comonomer distribution will exhibit a peak or maximum.

In an embodiment of the disclosure, the ethylene interpolymer product has a reversed comonomer distribution profile as measured using GPC-FTIR.

In an embodiment of the disclosure, the ethylene interpolymer product has a partially reversed comonomer distribution profile as measured using GPC-FTIR.

The ethylene interpolymer product will have a non-comonomer index distribution, NCIDᵢ, which is deconvolutable to an identifiable first fraction and identifiable second fraction with distinct non-comonomer index distributions, NCIDᵢ¹ and NCIDᵢ². The non-comonomer index distribution of the ethylene interpolymer product is measured experimentally using the triple detection cross fractionation chromatography (3D-CFC) technique disclosed in the General Testing Procedures section.

In an embodiment of the disclosure, the ethylene interpolymer product has a stress exponent (S.Ex.), defined as log₁₀ (I₆/I₂)/log₁₀ (6.48/2.16), which is <1.60. In further embodiments of the disclosure the ethylene interpolymer product has a stress exponent, log₁₀ (I₆/I₂)/log₁₀ (6.48/2.16) of less than 1.50, or less than 1.45, or less than 1.44, or less than 1.42.

In an embodiment of the disclosure, the ethylene interpolymer product has a dimensionless long chain branching factor, LCBF of ≥0.005. In an embodiment, the ethylene interpolymer product has a LCBF of ≤0.04. In an embodiment, the ethylene interpolymer product has a LCBF of ≥0.01. In an embodiment, the ethylene interpolymer product has a LCBF of from 0.005 to 0.042, or from 0.005 to 0.04, or from 0.0054 to 0.04, or from 0.01 to 0.0354, or from 0.0114 to 0.0354, or from 0.0114 to 0.0294, or from 0.0174 to 0.0294. In an embodiment, the ethylene interpolymer product has a LCBF of ≤0.04, or <0.04, or <0.0354, or K 0.035, or <0.035, or <0.03 or <0.03, or <0.0294, or <0.0294, or <0.0234, or <0.0234. In an embodiment, the ethylene interpolymer product has a LCBF of ≥0.005, or >0.005, or >0.0054, or >0.0054, or >0.01, or >0.01, or >0.0114, or >0.0114, or >0.0174, or >0.0174.

In an embodiment, the ethylene interpolymer product has a sum of unsaturation, SUM^{u} of ≥0.047 per 100 carbon atoms. In an embodiment, the ethylene interpolymer product has a SUM^{u} of ≤0.07 per 100 carbon atoms. In an embodiment, the ethylene interpolymer product has a SUM^{u} of from 0.047 per carbon atoms to 0.07 per 100 carbon atoms, or from 0.047 per 100 carbon atoms to 0.0675 per 100 carbon atoms, or from 0.050 per 100 carbon atoms to 0.0675 per 100 carbon atoms, or from 0.05 per 100 carbon atoms to 0.064 per 100 carbon atoms, or from 0.05 per 100 carbon atoms to 0.06 per 100 carbon atoms. In an embodiment, the ethylene interpolymer product has a SUM^{u} of ≤0.1 per 100 carbon atoms, or <0.1 per 100 carbon atoms, or K 0.09 per 100 carbon atoms, or K 0.07 per 100 carbon atoms, or <0.07 per 100 carbon atoms, or <0.0678 pr 100 carbon atoms, or <0.0678 per 100 carbon atoms, or <0.0675 per 100 carbon atoms, or <0.0675 per 100 carbon atoms, or K 0.064 per 100 carbon atoms, or <0.064 per 100 carbon atoms. In an embodiment, the ethylene interpolymer product has a SUM^{u} of ≥0.047 per 100 carbon atoms, or >0.047 per 100 carbon atoms, or >0.048 per 100 carbon atoms, or >0.048 per 100 carbon atoms, or >0.049 per 100 carbon atoms, or >0.049 per 100 carbons, or >0.05 per 100 carbon atoms, or >0.05 per 100 carbon atoms, or >0.051 per 100 carbon atoms, or >0.051 per 100 carbon atoms.

### Flexible Manufactured Articles

The ethylene interpolymer products disclosed herein may be converted into flexible manufactured articles such as monolayer or multilayer films.

A non-limiting example of a process to prepare monolayer or multilayer films includes blown processes.

In the blown film extrusion process, an extruder heats, melts, mixes and conveys a thermoplastic or a blend of thermoplastics. Once molten, the thermoplastic is forced through an annular die to produce a thermoplastic tube. In the case of coextrusion, multiple extruders are employed to produce a multilayer thermoplastic tube. The temperature of the extrusion process is primarily determined by the thermoplastic or thermoplastic blend being processed, for example the melting temperature or glass transition temperature of the thermoplastic and the desired viscosity of the melt. In the case of polyolefins, typical extrusion temperatures are from 330° F. to 550° F. (166° C. to 288° C.). Upon exit from the annular die, the thermoplastic tube is inflated with air, cooled, solidified and pulled through a pair of nip rollers. Due to air inflation, the tube increases in diameter forming a bubble of desired size. Due to the pulling action of the nip rollers the bubble is stretched in the machine direction. Thus, the bubble is stretched in two directions: the transverse direction (TD) where the inflating air increases the diameter of the bubble; and the machine direction (MD) where the nip rollers stretch the bubble. As a result, the physical properties of blown films are typically anisotropic, i.e., the physical properties differ in the MD and TD directions; for example, film tear strength and tensile properties typically differ in the MD and TD. In some prior art documents, the terms “cross direction” or “CD” is used; these terms are equivalent to the terms “transverse direction” or “TD” used in this disclosure.

In the blown film process, air is also blown on the external bubble circumference to cool the thermoplastic as it exits the annular die. The final width of the film is determined by controlling the inflating air or the internal bubble pressure; in other words, increasing or decreasing bubble diameter. Film thickness is controlled primarily by increasing or decreasing the speed of the nip rollers to control the draw-down rate. After exiting the nip rollers, the bubble or tube is collapsed and may be slit in the machine direction thus creating sheeting. Each sheet may be wound into a roll of film. Each roll may be further slit to create film of the desired width. Each roll of film is further processed into a variety of consumer products as described below.

Another example of a process to prepare monolayer or multilayer films includes cast film processes.

The cast film process is similar in that a single or multiple extruder(s) may be used; however, the various thermoplastic materials are metered into a flat die and extruded into a monolayer or multilayer sheet, rather than a tube. In the cast film process, the extruded sheet is solidified on a chill roll.

In the cast film process, films are extruded from a flat die onto a chilled roll or a nipped roll, optionally, with a vacuum box and/or air-knife. The cast films may be monolayer or coextruded multi-layer films obtained by various extrusion through a single or multiple dies. The resultant films may be used as—is or may be laminated to other films or substrates, for example by thermal, adhesive lamination or direct extrusion onto a substrate.

The resultant films and laminates may be subjected to other forming operations such as embossing, stretching, thermoforming. Surface treatments such as corona may be applied and the films may be printed.

Depending on the end-use application, the disclosed ethylene interpolymer product may be converted into monolayer or multilayer films that span a wide range of thicknesses.

Non-limiting examples include food packaging films, where thicknesses may range from about 0.5 mil to about 4 mil, and heavy duty sack applications, where film thickness may range from about 2 mil to about 10 mil.

The ethylene interpolymer product disclosed herein may be used in monolayer films; where the monolayer film may contain more than one ethylene interpolymer product and/or additional thermoplastics; non-limiting examples of thermoplastics include polyethylene polymers and propylene polymers. The lower limit on the weight percent of the ethylene interpolymer product in a monolayer film may be about 3 wt. %, in other cases about 10 wt. % and in still other cases about 30 wt. %. The upper limit on the weight percent of the ethylene interpolymer product in the monolayer film may be 100 wt. %, in other cases about 90 wt. % and in still other cases about 70 wt. %.

The ethylene interpolymer product disclosed herein may also be used in one or more layers of a multilayer film structure; non-limiting examples of multilayer films include three, five, seven, nine, eleven or more layers. The thickness of a specific layer (containing the ethylene interpolymer product) within a multilayer film structure may be about 5%, in other cases about 15% and in still other cases about 30% of the total multilayer film thickness. In other embodiments, the thickness of a specific layer (containing the ethylene interpolymer product) within a multilayer film structure may be about 95%, in other cases about 80% and in still other cases about 65% of the total multilayer film structure thickness.

Each individual layer of a multilayer film structure may contain more than one ethylene interpolymer product and/or additional thermoplastics.

Additional embodiments include laminations and coatings, wherein mono or multilayer films containing the disclosed ethylene interpolymer product are extrusion laminated or adhesively laminated or extrusion coated. In extrusion lamination or adhesive lamination, two or more substrates are bonded together with a thermoplastic or an adhesive, respectively. In extrusion coating, a thermoplastic is applied to the surface of a substrate.

These processes are well known to those experienced in the art. Frequently, adhesive lamination or extrusion lamination are used to bond dissimilar materials, non-limiting examples include the bonding of a paper web to a thermoplastic web, or the bonding of an aluminum foil containing web to a thermoplastic web, or the bonding of two thermoplastic webs that are chemically incompatible, e.g., the bonding of a ethylene interpolymer product containing web to a polyester or polyamide web. Prior to lamination, the web containing the disclosed ethylene interpolymer product(s) may be monolayer or multilayer. Prior to lamination the individual webs may be surface treated to improve the bonding, a non-limiting example of a surface treatment is corona treating. A primary web or film may be laminated on its upper surface, its lower surface, or both its upper and lower surfaces with a secondary web. A secondary web and a tertiary web could be laminated to the primary web; wherein the secondary and tertiary webs differ in chemical composition. As non-limiting examples, secondary or tertiary webs may include polyamide, polyester and polypropylene, or webs containing barrier resin layers such as EVOH. Such webs may also contain a vapor deposited barrier layer; for example, a thin silicon oxide (SiOx) or aluminum oxide (AlOx) layer. Multilayer webs (or films) may contain three, five, seven, nine, eleven or more layers.

The ethylene interpolymer product disclosed herein can be used in a wide range of manufactured articles comprising one or more films or film layers (monolayer or multilayer). Non-limiting examples of such manufactured articles include: food packaging films (fresh and frozen foods, liquids and granular foods), stand-up pouches, retortable packaging and bag-in-box packaging; barrier films (oxygen, moisture, aroma, oil, etc.) and modified atmosphere packaging; light and heavy duty shrink films and wraps, collation shrink film, pallet shrink film, shrink bags, shrink bundling and shrink shrouds; light and heavy duty stretch films, hand stretch wrap, machine stretch wrap and stretch hood films; high clarity films; heavy-duty sacks; household wrap, overwrap films and sandwich bags; industrial and institutional films, trash bags, can liners, magazine overwrap, newspaper bags, mail bags, sacks and envelopes, bubble wrap, carpet film, furniture bags, garment bags, coin bags, auto panel films; medical applications such as gowns, draping and surgical garb; construction films and sheeting, asphalt films, insulation bags, masking film, landscaping film and bags; geomembrane liners for municipal waste disposal and mining applications; batch inclusion bags; agricultural films, mulch film and green house films; in-store packaging, self-service bags, boutique bags, grocery bags, carry-out sacks and t-shirt bags; oriented films, machine direction and biaxially oriented films and functional film layers in oriented polypropylene (OPP) films, e.g. sealant and/or toughness layers. Additional manufactured articles comprising one or more films containing at least one ethylene interpolymer product include laminates and/or multilayer films; sealants and tie layers in multilayer films and composites; laminations with paper; aluminum foil laminates or laminates containing vacuum deposited aluminum; polyamide laminates; polyester laminates; extrusion coated laminates, and; hot-melt adhesive formulations. The manufactured articles summarized in this paragraph contain at least one film (monolayer or multilayer) comprising at least one embodiment of the disclosed ethylene interpolymer product.

Cast films and laminates made from ethylene interpolymer products of the present disclosure may be used in a variety of end-uses, such as for example, for food packaging (dry foods, fresh foods, frozen foods, liquids, processed foods, powders, granules), for packaging of detergents, toothpaste, towels, for labels and release liners. The cast films may also be used in unitization and industrial packaging, notably in stretch films. The cast films may also be suitable in hygiene and medical applications, for example in breathable and non-breathable films used in diapers, adult incontinence products, feminine hygiene products, ostomy bags. The ethylene interpolymer products of the present disclosure may also be useful in tapes and artificial turf applications.

Desired film physical properties (monolayer or multilayer) typically depend on the application of interest. Non-limiting examples of desirable film properties include: optical properties (gloss, haze and clarity), dart impact, Elmendorf tear, modulus (1% and 2% secant modulus), puncture-propagation tear resistance, tensile properties (yield strength, break strength, elongation at break, toughness, etc.) and heat sealing properties (heat seal initiation temperature and hot tack strength). Specific hot tack and heat sealing properties are desired in high speed vertical and horizontal form-fill-seal processes that load and seal a commercial product (liquid, solid, paste, part, etc.) inside a pouch-like package.

In addition to desired film physical properties, it is desired that the disclosed ethylene interpolymer product is easy to process on film lines. Those skilled in the art frequently use the term “processability” to differentiate polymers with improved processability, relative to polymers with inferior processability. A commonly used measure to quantify processability is extrusion pressure; more specifically, a polymer with improved processability has a lower extrusion pressure (on a blown film or a cast film extrusion line) relative to a polymer with inferior processability.

The films used in the manufactured articles described in this section may optionally include, depending on its intended use, additives and adjuvants. Non-limiting examples of additives and adjuvants include, anti-blocking agents, antioxidants, heat stabilizers, slip agents, processing aids, anti-static additives, colorants, dyes, filler materials, light stabilizers, light absorbers, lubricants, pigments, plasticizers, nucleating agents and combinations thereof.

An embodiment of the disclosure is a film layer comprising the ethylene interpolymer product described herein.

In an embodiment, a film layer is a blown film.

In an embodiment, a film layer is a cast film.

In embodiment, a film layer has a thickness of from 0.5 to 10 mil.

An embodiment of the disclosure is a multilayer film structure comprising at least one film layer comprising the ethylene interpolymer product described herein.

In an embodiment, a multilayer film structure is a blown film structure.

In an embodiment, a multilayer film structure has a thickness of from 0.5 to 10 mil.

An embodiment of the disclosure is a multilayer film structure comprising a core layer, the core layer comprising the ethylene interpolymer product described herein.

An embodiment of the disclosure is a multilayer film structure comprising a sealant layer, the sealant layer comprising the ethylene interpolymer product disclosed herein.

### General Testing Procedures

Prior to testing, each specimen was conditioned for at least 24 hours at 23±2° C. and 50±10% relative humidity and subsequent testing was conducted at 23±2° C. and 50±10% relative humidity. Herein, the term “ASTM conditions” refers to a laboratory that is maintained at 23±2° C. and 50±10% relative humidity; and specimens to be tested were conditioned for at least 24 hours in this laboratory prior to testing. ASTM refers to the American Society for Testing and Materials.

### Density

Ethylene/α-olefin copolymer density in the solid state was determined using ASTM D792-13 (Nov. 1, 2013).

### Melt Index

Ethylene/α-olefin copolymer melt index was determined using ASTM D1238 (Aug. 1, 2013). Melt indexes, I₂ was measured at 190° C., using a weight of 2.16 kg.

### Melt Strength

The melt strength is measured on Rosand RH-7 capillary rheometer (barrel diameter=15 mm) with a flat die of 2-mm Diameter, L/D ratio 10:1 at 190° C. Pressure Transducer: 10,000 psi (68.95 MPa). Piston Speed: 5.33 mm/min. Haul-off Angle: 52°. Haul-off incremental speed: 50-80 m/min2 or 65±15 m/min². A polymer melt sample is extruded through a capillary die under a constant rate and then the polymer strand is drawn at an increasing haul-off speed until it ruptures. The maximum steady value of the force in the plateau region of a force versus time curve is defined as the melt strength for the polymer.

### Non-Comonomer Index Distribution

The non-comonomer index distribution (NCIDᵢ dimensionless) of ethylene interpolymer products of the present disclosure were measured experimentally using triple detection cross fractionation chromatography (3D-CFC).

In the 3D-CFC experiments, a polymer sample (150 to 300 mg) was introduced into the sample dissolution vessel of the Polymer Char Crystaf-TREF unit. The sample dissolution vessel was then filled with 35 ml 1,2,4-trichlorobenzene (TCB) containing 250 ppm antioxidant 2,6-di-tert-butyl-4-methylphenol (BHT), heated to the desired dissolution temperature (e.g., 140° C.) and stirred for 2 to 3 hours. The polymer solution (1.5 ml) was then loaded into the TREF column filled with stainless steel beads. After being allowed to equilibrate at a given stabilization temperature (e.g., 110° C.) for 20 to 45 minutes, the polymer solution was allowed to crystallize with a temperature drop from the stabilization temperature to 30° C. (0.2° C./minute). After equilibrating at 30° C. for 90 minutes, the crystallized sample was eluted with TCB from 30° C. to 140° C., while dividing the effluent into a number of fractions (e.g., 5 to 20 fractions). For each fraction, the TREF column was heated (the heating rate in the step-elution was 1.0° C./minute) to the specific dissolution temperature and maintained at that temperature for at least 50 minute before the solution of the fraction was eluted and introduced directly to a SEC system through a heated transfer line. All above steps, including the sample dissolution, sample solution loading into TREF column, crystallization and elution, were programmed and controlled with the Polymer Char TREF software with the step-elution capability.

The various polymer fractions were chromatographed at 140° C. on a PL 220 high-temperature chromatography unit equipped with either four SHODEX® columns (HT803, HT804, HT805 and HT806), or four PL Mixed ALS or BLS columns, and with a differential refractive index (DRI) as the concentration detector. A dual-angle light scattering detector (15 and 90 degree) and a differential viscometer were used to measure the molar mass and intrinsic viscosity, respectively. TCB was the mobile phase with a flow rate of 1.0 mL/minute, BHT was added to the mobile phase at a concentration of 250 ppm to protect SEC columns from oxidative degradation. The data were acquired using CIRRUS GPC software and processed with CIRRUS® GPC software and Excel spreadsheet to produce absolute molar masses and intrinsic viscosity [r/].

Alternatively, the 3D-CFC experiments can be performed using a Polymer Char CEF instrument with a step-elution capability. A polymer sample (50 to 100 mg) was introduced into the sample dissolution vial of the Polymer Char Crystaf-TREF unit and the vial loaded to the auto-sampler. The sample dissolution vial was then filled with 6 to 7 ml 1,2,4-trichlorobenzene (TCB) containing 250 ppm antioxidant 2,6-di-tert-butyl-4-methylphenol (BHT), heated to the desired dissolution temperature (e.g., 160° C.) and shaken for 2 to 3 hours. The polymer solution (0.2 ml) was then loaded into the TREF column filled with stainless steel beads. After being allowed to equilibrate at a given stabilization temperature (e.g., 110° C.) for 20 to 45 minutes, the polymer solution was allowed to crystallize with a temperature drop from the stabilization temperature to 30° C. (0.2° C./minute). After equilibrating at 30° C. for 30 minutes, the crystallized sample was eluted with TCB from 30° C. to 140° C., while dividing the effluent into a number of fractions (e.g., 4 to 10 fractions). For each fraction, the TREF column was heated to the specific dissolution temperature and maintained at that temperature for 15 to 30 minutes before the solution of the fraction was eluted and introduced directly to a set of SEC columns sitting on the top oven. All above steps, including the sample dissolution, sample solution loading into TREF column, crystallization and elution, were programmed and controlled with the Polymer Char CEF software with the step-elution capability.

The various polymer fractions were chromatographed at 140° C. with two to four PL Mixed ALS or BLS columns, and with a Polymer Char IR4 as the concentration detector. A Polymer Char four-bridge viscometer and a multiangle light scattering detector (HELEOS II MALS, Wyatt Technology) were used to measure the intrinsic viscosity and molar mass, respectively. TCB was the mobile phase with a flow rate of 0.5 or 1.0 mL/minute, BHT was added to the mobile phase at a concentration of 250 ppm to protect SEC columns from oxidative degradation. The data were acquired using CIRRUS GPC software or ASTRA® software and processed with CIRRUS GPC software or ASTRA software and Excel spreadsheet to produce absolute molar masses and intrinsic viscosity [q].

The term “absolute” molar mass was used to distinguish 3D-SEC determined absolute molar masses from the molar masses determined by conventional SEC. The viscosity average molar mass (My) and intrinsic viscosity [q] of each 3D-CFC TREF fraction determined by 3D-CFC were used in calculations to determine the non-comonomer index (NCI) and the non-comonomer index distribution (NCIDᵢ) according to the following equations:

$${NCI}^{f} = \frac{{K}_{m}^{f}}{{K}_{co}} = \frac{1000000 ( {[ η ]}^{f} / {( {M}_{v}^{f} )}^{0.725} )}{( 391.98 - A \times ( B \times {T}^{f} + C )} \qquad eq . ( 4 )$$

$${NCID}_{i} = {\sum }_{1}^{f} {x}^{f} {( {w}_{i} log ( {M}_{i} ) )}^{f} \times {NCI}^{f} \qquad eq . ( 5 )$$

in which (Mᵥ^{f}) (g/mole) and [η]^{f} (dL/g) were the viscosity average molar mass and the intrinsic viscosity, respectively, of the f-th TREF fraction as determined with 3D-CFC; T^{f} was the weight average TREF elution temperature of the f-th TREF fraction (details regarding T^{f} are described below); and A, B and C were constants specific to the α-olefin comonomer in the ethylene/α-olefin interpolymer under test. In the case of 1-octene: A was 2.1626; B was −0.6737 and C was 63.6727. Constants A, B and C for other α-olefins were determined experimentally (non-limiting examples include 1-hexene). Elaborating, a series of linear ethylene/α-olefin interpolymers with different comonomer contents were analyzed with triple detection size exclusion chromatography (3D-SEC) in TCB at 140° C., in which the viscosity average molar masses (My) and the intrinsic viscosities ([η]) of the linear ethylene/α-olefin interpolymers were determined and were used to calculate the Mark-Houwink constants K based on the Mark-Houwink equation [q]=K×(Mᵥ)a. Well-known to those of ordinary experience, the Mark-Houwink constant α is 0.725 for ethylene/α-olefin interpolymers. Using simple regression, a plot of Mark-Houwink constants K versus comonomer contents [CH₃/1000 C] of the linear ethylene/α-olefin interpolymers generated the following relationship:

$$K = ( slope ) [ {CH}_{3} / 1 \; 000 C ] + intercept \qquad eq . ( 6 )$$

In this disclosure, the constant A in eq.(4) was defined by the (slope)-4.6); specifically, A=−1000000×(slope). The constants B and C in eq.(4) were calculated from the linear correlation between comonomer contents and the weight average elution temperatures of ethylene/α-olefin interpolymers based on re-constructed analytical TREF profiles of the ethylene/α-olefin interpolymers (see details below); the constant B was the slope and the constant C was the intercept. For example, in this disclosure for α-octene comonomer, constants A, B and C were 2.1626, -0.6737 and 63.6727, respectively.

In eq.(4), the weight average TREF elution temperature of the f-th 3D-CFC TREF fraction T^{f}, was calculated based on the re-constructed analytical TREF profile of the ethylene/α-olefin interpolymer. The re-constructed analytical TREF profile was obtained by simply replacing the original elution temperatures in analytical TREF analysis performed on a Polymer Char Crystaf-TREF instrument, hereafter CTREF, with the equivalents of 3D-CFC elution temperature. The conversion of the original elution temperatures to the equivalents of 3D-CFC elution temperature enables one to compensate for differences in flow during the elution stage, i.e., dynamic (with a flow) while heating in CTREF, in contrast with static elution (without a flow) while heating in 3D-CFC; as well as for any other difference between these instruments (if any). To do this conversion, a series of ethylene/α-olefin interpolymers having different comonomer contents and randomly distributed comonomer units were analyzed with both CTREF (Polymer Char Crystaf-TREF unit) and 3D-CFC. In this calibration procedure, the range of elution temperature in 3D-CFC analysis for each TREF fraction was very narrow (e.g., 1 to 2 degrees whenever possible and not greater than 5 degrees) and the average of the low and high temperatures of the TREF fraction was used to define the elution temperature of the 3D-CFC TREF fraction, e.g., 42.5° C. was the elution temperature for the 40° C. to 45° C. fraction.

The weight average elution temperature of the entire ethylene/α-olefin interpolymer was calculated from the weight fraction and the elution temperature of each 3D-CFC TREF fraction. From the correlations between comonomer contents and the weight average elution temperatures of ethylene/α-olefin interpolymers in 3D-CFC and CTREF, the relation between the weight average elution temperatures between 3D-CFC and CTREF could be established and this relation was used to convert the original elution temperatures in CTREF analysis to 3D-CFC elution temperatures.

In this disclosure, the relation between the weight average elution temperatures of 3D-CFC (T_{CFC}) and the weight average elution temperatures of CTREF (T_{CTREF}) was described by the relationship T_{CFC}=0.9776X_{CTREF}−0.7156. This relationship was used to convert the original CTREF elution temperatures to the equivalents of 3D-CFC elution temperature in re-construction of the analytical TREF profiles, for calculating the T^{f}, the weight average TREF elution temperature of the f-th 3D-CFC TREF fraction and for calculating the constants B and C in eq.(4).

While not wishing to be bound by any theory, it is believed that the obtained non-comonomer index distribution is a combined indicator of the presence and distribution of intermediate branching (defined as a non-rheologically active branch which is longer than the branch length due to comonomer) and long chain branching (defined as a “rheologically active” branch—see the following section on Long Chain Branching Factor).

### Long Chain Branching Factor (LCBF)

The LCBF (dimensionless) was determined for the ethylene interpolymer product using the method described in U.S. Pat. Appl. Pub. No. 2018/0305531 which is incorporated herein by reference.

In the present disclosure, a long chain branch has a molecular weight equal to, or greater than, the entanglement molecular weight, Mₑ. Mₑ is a well-known concept in polymer physics (e.g., reported to be about 1 kg/mol for polyethylenes, see Fetters et al., Macromolecules 1999, 32, 6847). In this disclosure, long chain branches were characterized as “rheologically active”. The term “rheologically active” means the presence of long chain branches in a sample was evident after comparing rheological test results with a comparative sample that did not contain long chain branches. Non-limiting examples of rheological test results include, flow activation energy (Eₐ), shear thinning or viscosity ratios, melt flow ratios (I₂₁/I₂, I₁₀/I₂, etc.), melt strength and long chain branching factor (LCBF), etc.

LCBF calculation involved calculating a polydispersity corrected zero-shear viscosity (ZSV_{c}) and a SCB corrected intrinsic viscosity (IV_{c}). The polydispersity correction applied to the zero-shear viscosity, ZSV_{c}, had dimensions of Poise, and was performed as shown in equation eq.(7):

$${ZSV}_{c} = \frac{1.8389 \times {η}_{0}}{2.411 {0}^{Ln ( Pd )}} \qquad eq . ( 7 )$$

in which η₀, the zero-shear viscosity (Poise), was measured by a dynamic mechanical analysis test procedure (see the testing procedure under the heading “Dynamic Mechanical Analysis”); Pd was the dimensionless polydispersity (i.e., M_{w}/Mₙ) as measured using conventional SEC (see the testing procedure under the heading “Conventional Size Exclusion Chromatography”); 1.8389 and 2.4110 were dimensionless constants.

Calculation of the SCB-corrected intrinsic viscosity IV_{c} (having dimensions of dL/g) was performed as shown in equation eq.(8),

$${IV}_{c} = [ η ] + \frac{A \times SCB \times {M}_{v}^{0.725}}{1000000} \qquad eq . ( 8 )$$

in which the intrinsic viscosity [η](dL/g) was measured using 3D-SEC (see the testing procedure under the heading “Triple Detection Size Exclusion Chromatography”), SCB having dimensions of (CH₃/1000 C) which was determined using FTIR (see the testing procedure under the heading “Comonomer Cotent: Fourier Transform Infrared Spectroscopy”), and the viscosity average molar mass My (g/mole) was determined using 3D-SEC (see testing procure under the heading “Triple Detection Size Exclusion Chromatography”). The comonomer dependent constant A was defined above in the context of Eq. (6). In the case of an ethylene homopolymer no correction is required for the Mark-Houwink constant, i.e., SCB is zero.

Non-long chain branched ethylene interpolymer products (i.e., ethylene interpolymer products which do not contain LCB or undetectable levels of LCB) fall on a “reference line” as defined by the following equation.

$$Log ( {IV}_{c} ) = 0.2100 \times Log ( {ZSV}_{c} ) - 0 \text{.7879} \qquad eq . ( 9 )$$

The calculation of the LCBF was based on horizontal (Sₕ) and vertical (Sᵥ) shifts from the above-described linear reference line, as laid out by the following equations:

$${S}_{h} = Log ( {ZSV}_{c} ) - 4.7619 \times Log ( {IV}_{c} ) - 3 \text{.7519} \qquad eq . ( 10 )$$

$${S}_{v} = 0.2100 \times Log ( {ZSV}_{c} ) - Log ( {IV}_{c} ) - 0 \text{.7879} \qquad eq . ( 11 )$$

In eq.(10) and eq.(11), it was required that the polydispersity corrected zero-shear viscosity ZSV_{c} and the SCB corrected intrinsic viscosity IV_{c} have dimensions of Poise and dL/g, respectively. The horizontal shift factor (Sₕ) was a shift in ZSV_{c} at a constant IV_{c}. If one removes the Log function its physical meaning is apparent, i.e., a ratio of two ZSV_{cs}, i.e., the ZSV_{c} of the sample under test relative to the ZSV_{c} of a linear ethylene interpolymer product having the same IV_{c}. The horizontal shift factor (Sₕ) was dimensionless.

The vertical shift (Sᵥ) was a shift in IV_{c} at a constant ZSV_{c}. Again, if one removes the Log function its physical meaning is apparent, i.e., a ratio of two IV_{cs} of a linear ethylene interpolymer product having the same ZSV_{c} relative to the IV_{c} of the sample under test. The vertical shift factor (Sᵥ) was dimensionless.

Finally, in the present disclosure a dimensionless long chain branching factor (LCBF) was defined by eq.(12):

$$LCBF = \frac{{s}_{h} \times {s}_{v}}{2} \qquad eq . ( 12 )$$

### Comonomer Content: Fourier Transform Infrared (FTIR) Spectroscopy

The quantity of comonomer in an ethylene interpolymer product was determined by FTIR and reported as the Short Chain Branching (SCB) content having dimensions of CH₃/1000 C (number of methyl branches per 1000 carbon atoms). This test was completed according to ASTM D6645-01 (2001), employing a compression molded polymer plaque and a Thermo-Nicolet 750 Magna-IR Spectrophotometer. The polymer plaque was prepared using a compression molding device (Wabash-Genesis Series press) according to ASTM D4703-16 (April 2016).

### Dynamic Mechanical Analysis (DMA)

Oscillatory shear measurements under small-strain amplitudes were carried out to obtain linear viscoelastic functions at 190° C. under nitrogen atmosphere, at a strain amplitude of 10% and over a frequency range of 0.02-126 rad/s at 5 points per decade. Frequency sweep experiments were performed with a TA Instruments DHR3 stress-controlled rheometer using cone-plate geometry with a cone angle of 5°, a truncation of 137 m and a diameter of 25 mm. In this experiment a sinusoidal strain wave was applied, and the stress response was analyzed in terms of linear viscoelastic functions. The zero-shear rate viscosity (η₀) based on the DMA frequency sweep results was determined by fitting a 4-parameter Carreau-Yasuda viscosity model into the complex viscosity versus angular frequency defined by

$$\vert {η}^{*} \vert = {{η}_{0} [ 1 + {( {τ}_{c} ω )}^{a} ]}^{\frac{n - 1}{a}}$$

in which |η*| is complex viscosity measured as a function of angular frequency co, a (or CY-a as referred to in the EXAMPLES section) is a parameter determining the breadth of transition from a Newtonian plateau to shear-thinning region with a slope of n−1 in a log-log plot. In the present disclosure the parameter n is set to a constant value of 2/11 and rest of model parameters were fitted by a least square method.

### Triple Detection Size Exclusion Chromatography (3D-SEC)

Polymer solutions (1 to 3 mg polymer/mL) were prepared by heating the ethylene interpolymer product sample in 1,2,4-trichlorobenzene (TCB) and rotating on a wheel for 4 hours at 150° C. in an oven. An antioxidant, 2,6-di-tert-butyl-4-methylphenol (BHT), was added to the mixture to stabilize the polymer sample against oxidative degradation. The BHT concentration was 250 ppm. Sample solutions were chromatographed at 140° C. on a PL 220 high temperature chromatography unit equipped with a differential refractive index (DRI) detector, a dual-angle light scattering detector (15 and 90 degree) and a differential viscometer. The SEC columns used were either four SHODEX columns (HT803, HT804, HT805 and HT806), or four PL Mixed ALS or BLS columns. TCB was the mobile phase with a flow rate of 1.0 mL/minute, BHT was added to the mobile phase at a concentration of 250 ppm to protect SEC columns from oxidative degradation. The sample injection volume was 200 μL. The SEC raw data were processed with the CIRRUS GPC software, to produce absolute molar masses and intrinsic viscosity ([η]) and viscosity average molar mass (My). The term “absolute” molar mass was used to distinguish 3D-SEC determined absolute molar masses from the molar masses determined by conventional SEC. The viscosity average molar mass (My) and intrinsic viscosity ([η]) determined by 3D-SEC were used in calculations to determine the long chain branching factor (LCBF).

### Conventional Size Exclusion Chromatography (SEC)

Polymer solutions (1 to 3 mg/mL) were prepared by heating the polymer in 1,2,4-trichlorobenzene (TCB) and rotating on a wheel for 4 hours at 150° C. in an oven. An antioxidant, 2,6-di-tert-butyl-4-methylphenol (BHT), was added to the mixture in order to stabilize the polymer against oxidative degradation. The BHT concentration was 250 ppm. Polymer solutions were chromatographed at 140° C. on a PL 220 high-temperature chromatography unit equipped with four SHODEX columns (HT803, HT804, HT805 and HT806) using TCB as the mobile phase with a flow rate of 1.0 mL/minute, with a differential refractive index (DRI) as the concentration detector. BHT was added to the mobile phase at a concentration of 250 ppm to protect GPC columns from oxidative degradation. The sample injection volume was 200 μL. The GPC columns were calibrated with narrow distribution polystyrene standards. The polystyrene molecular weights were converted to polyethylene molecular weights using the Mark-Houwink equation, as described in the ASTM standard test method D6474-12 (December 2012). The GPC raw data were processed with the CIRRUS GPC software, to produce molar mass averages (Mₙ, M_{w}, M_{z}) and molar mass distribution (e.g., Polydispersity, M_{w}/Mₙ). In the polyethylene art, a commonly used term that is equivalent to SEC is GPC, i.e., Gel Permeation Chromatography.

### Unsaturation

The quantity of unsaturated groups, i.e., double bonds, in an ethylene interpolymer product was determined according to ASTM D3124-98 (published March 2011) and ASTM D6248-98 (published July 2012). An ethylene interpolymer product sample was: a) first subjected to an overnight carbon disulfide extraction to remove additives that may interfere with the analysis; b) the sample (pellet, film or granular form) was pressed into a plaque of uniform thickness (0.5 mm); and c) the plaque was analyzed by FTIR to quantify the amount of terminal (vinyl) and internal unsaturation (trans-vinylene); and d) the sample plaque was brominated and reanalyzed by FTIR to quantify the amount of side chain unsaturation (vinylidene). The IR resonances of these groups appear at 908 cm¹, 965 cm-1 and 888 cm⁻¹, respectively. The procedure is based on Beer's Law: A=a×b×d×c, where a is the extinction coefficient for the specific unsaturation being measured, b is the plaque thickness, d the plaque density and c the selected unsaturation. Experimentally, the weight and area of the plaque are measured rather than the density and the thickness. In the present disclosure, the amount of internal (I^{u}), side chain (SC^{u}) and terminal (T^{u}) were then used to calculate the sum of unsaturation (SUM^{u}) in unsaturation per 100 carbon atoms according to

$${SUM}^{u} = 2 \times + {I}^{u} + {SC}^{u} + {T}^{u} .$$

### GPC-FTIR

Polymer solutions were prepared by heating 2 to 4 mg/mL of the ethylene interpolymer product sample in 1,2,4-trichlorobenzene (TCB) and rotating on a wheel for 4 hours at 150° C. in an oven. The antioxidant 2,6-di-tert-butyl-4-methylphenol (BHT) was added to the mixture in order to stabilize the polymer against oxidative degradation. The BHT concentration was 250 ppm. Sample solutions were chromatographed at 140° C. on a Waters GPC 150C chromatography unit equipped with four SHODEX columns (HT803, HT804, HT805 and HT806) using TCB as the mobile phase with a flow rate of 1.0 mL/minute, with a FTIR spectrometer and a heated FTIR flow through cell coupled with the chromatography unit through a heated transfer line as the detection system. BHT was added to the mobile phase at a concentration of 250 ppm to protect SEC columns from oxidative degradation. The sample injection volume was 300 μL. The raw FTIR spectra were processed with OPUS® FTIR software, and the polymer concentration and methyl content were calculated in real time with the Chemometric Software (PLS technique) associated with the OPUS. Then the polymer concentration and methyl content were acquired and baseline-corrected with the CIRRUS GPC software. The SEC columns were calibrated with narrow distribution polystyrene standards. The polystyrene molecular weights were converted to polyethylene molecular weights using the Mark-Houwink equation, as described in the ASTM standard test method D6474. The comonomer content was calculated based on the polymer concentration and methyl content predicted by the PLS technique as described in Paul J. DesLauriers, Polymer 43, pages 159-170 (2002); herein incorporated by reference.

The GPC-FTIR method measures total methyl content, which includes the methyl groups located at the ends of each macromolecular chain, i.e. methyl end groups. Thus, the raw GPC-FTIR data must be corrected by subtracting the contribution from methyl end groups. To be clear, the raw GPC-FTIR data overestimates the amount of short chain branching (SCB) and this overestimation increases as molecular weight decreases. In this disclosure, raw GPC-FTIR data was corrected using the 2-methyl correction. At a given molecular weight (M), the number of methyl end groups (N_{E}) was calculated using the following equation; N_{E}=28000/M, and N_{E} (M dependent) was subtracted from the raw GPC-FTIR data to produce the SCB per 1000 carbon atoms (2-Methyl corrected) GPC-FTIR data.

### Composition Distribution Branching Index (CDBI)

The “composition distribution branching index”, hereinafter CDBI, of the disclosed Examples and Comparative Examples were measured using a CRYSTAF/TREF 200+unit equipped with an IR detector, hereinafter CTREF. The acronym “TREF” refers to Temperature Rising Elution Fractionation. The CTREF was supplied by Polymer Char S.A. (Valencia Technology Park, Gustave Eiffel, 8, Paterna, E-46980 Valencia, Spain). The CTREF was operated in the TREF mode, which generates the chemical composition of the polymer sample as a function of elution temperature, the Co/Ho ratio (copolymer/homopolymer ratio) and the CDBI (the composition distribution breadth index), i.e., CDBI₅₀. A polymer sample (80 to 100 mg) was placed into the reactor vessel of the CTREF. The reactor vessel was filled with 35 ml of 1,2,4-trichlorobenzene (TCB) and the polymer was dissolved by heating the solution to 150° C. for 2 hours. An aliquot (1.5 mL) of the solution was then loaded into the CTREF column which was packed with stainless steel beads. The column, loaded with sample, was allowed to stabilize at 110° C. for 45 minutes.

The polymer was then crystallized from solution, within the column, by dropping the temperature to 30° C. at a cooling rate of 0.09° C./minute. The column was then equilibrated for 30 minutes at 30° C. The crystallized polymer was then eluted from the column with TCB flowing through the column at 0.75 mL/minute, while the column was slowly heated from 30° C. to 120° C. at a heating rate of 0.25° C./minute. The raw CTREF data were processed using Polymer Char software, an Excel spreadsheet and CTREF software developed in-house. CDBI₅₀ was defined as the percent of polymer whose composition was within 50% of the median comonomer composition; CDBI₅₀ was calculated from the composition distribution cure and the normalized cumulative integral of the composition distribution curve, as described in U.S. Pat. No. 5,376,439. Those skilled in the art will understand that a calibration curve was required to convert a CTREF elution temperature to comonomer content, i.e., the amount of comonomer in the ethylene/α-olefin polymer fraction that eluted at a specific temperature. The generation of such calibration curves were described in the prior art, e.g., Wild, et al., J. Polym. Sci., Part B, Polym. Phys., Vol. 20 (3), pages 441-455: hereby fully incorporated by reference. At the end of each sample run, the CTREF column was cleaned for 30 minutes; specifically, with the CTREF column temperature at 160° C., TCB flowed (0.5 mL/minute) through the column for 30 minutes.

### Film Tensile

The following film tensile properties were determined using ASTM D882-12 (Aug. 1, 2012): tensile break strength (MPa), elongation at break (%), tensile yield strength (MPa), tensile elongation at yield (%) and tensile energy to break (J). Tensile properties were measured in the both the machine direction (MD) and the transverse direction (TD) of the blown films.

### Film Secant Modulus

The secant modulus is a measure of film stiffness. The secant modulus is the slope of a line drawn between two points on the stress-strain curve, i.e., the secant line. The first point on the stress-strain curve is the origin, i.e., the point that corresponds to the origin (the point of zero percent strain and zero stress); and the second point on the stress-strain curve is the point that corresponds to a strain of 1%; given these two points the 1% secant modulus is calculated and is expressed in terms of force per unit area (MPa). The 2% secant modulus is calculated similarly. This method is used to calculated film modulus because the stress-strain relationship of polyethylene does not follow Hook's law; i.e., the stress-strain behavior of polyethylene is non-linear due to its viscoelastic nature. Secant moduli were measured using a conventional Instron tensile tester equipped with a 200 lbf load cell. Strips of monolayer film samples were cut for testing with following dimensions: 14 inch long, 1 inch wide and 1 mil thick; ensuring that there were no nicks or cuts on the edges of the samples. Film samples were cut in both the machine direction (MD) and the transverse direction (TD) and tested. ASTM conditions were used to condition the samples. The thickness of each film was accurately measured with a hand-held micrometer and entered along with the sample name into the Instron software. Samples were loaded in the Instron with a grip separation of 10 inch and pulled at a rate of 1 inch/min generating the strain-strain curve. The 1% and 2% secant modulus were calculated using the Instron software.

### Film Dart Impact

Film dart impact strength was determined using ASTM D1709-09 Method A (May 1, 2009). In this disclosure the dart impact test employed a 1.5 inch (38 mm)diameter hemispherical headed dart.

### Film Elmendorf Tear

Film tear performance was determined by ASTM D1922-09 (May 1, 2009); an equivalent term for tear is “Elmendorf tear”. Film tear was measured in both the machine direction (MD) and the transverse direction (TD) of the blown films.

### EXAMPLES

The following examples are presented for the purpose of illustrating selected embodiments of this disclosure—it being understood that the examples presented do not limit the claims presented.

### Ethylene Interpolymer Products

Ethylene interpolymer products in Examples 1-13 were each made using a mixed dual catalyst system in a commercial “in-series” multi-reactor solution polymerization process where the ethylene interpolymer product was made by forming a first ethylene interpolymer in a first reactor (R1); forming a second ethylene interpolymer in a second reactor (R2); and forming a third ethylene interpolymer in a third reactor (R3), where R1, R2 and R3 were configured in series with one another. An “in series” multi-reactor, solution phase polymerization process, including one employing a mixed dual catalyst has been described in U.S. Pat. Appl. Pub. No. 2018/0305531.

The R1 pressure was from about 14 MPa to about 18 MPa; while R2 was operated at a lower pressure to facilitate continuous flow from R1 to R2. Both R1 and R2 were continuously stirred reactors (CSTR's) and were agitated to give conditions in which the reactor contents were well mixed. Two CSTR reactors (R1 and R2) were configured in series followed by the third reactor (R3). The third rector (R3) was a tubular reactor. The process was operated continuously by feeding fresh process solvent, ethylene, 1-octene and hydrogen to the first and second reactors (R1 and R2) and in the removal of product. Methylpentane was used as the process solvent (a commercial blend of methylpentane isomers). Monomer (ethylene) and comonomer (1-octene) were purified prior to addition to the reactor using conventional feed preparation systems-such as contact with various absorption media to remove impurities such as water, oxygen and polar contaminants. The reactor feeds were pumped to the reactors R1 and R2 at the ratios shown in Tables 1A-1C. R1 feed temperature in Examples 1-13 was controlled at 24.1, 30.0, 30.0, 23.9, 23.9, 24.0, 24.0, 24.1, 30.0, 24.2, 24.0, 24.0, and 24.0, respectively. R2 feed temperature in Examples 1-13 was controlled at 25.0, 40.0, 40.0, 41.9, 24.9, 25.0, 25.0, 25.0, 40.0, 25.0, 25.0, 25.0, and 25.0, respectively.

In operating the continuous solution polymerization process shown in Tables 1A-1C, the total amount of ethylene supplied to the process were portioned or split between the three reactors R1, R2 and R3. In Tables 1A, 1B and 1C, this operational variable was called the ethylene split (ES), i.e., ES^{R1}, ES^{R2} and ES^{R3} referred to the weight percent of ethylene injected in R1, R2 and R3, respectively; with the proviso that ES^{R1}+ES^{R2}+ES^{R3} 100%. 1-Octene was also added to the continuous solution polymerization process and was proportioned or split between R1, R2 and R3. In Tables 1A, 1B and 1C, this operational variable was called the 1-octene split (OS), i.e., OS^{R1}, OS^{R2} and OS^{R3} referred to the weight percent of 1-octene comonomer that was injected in R1, R2 and R3, respectively; with the proviso that OS^{R1}+OS^{R2}+OS^{R3} 100%.

In operating the continuous solution polymerization process shown in Tables 1A-1C, the total amount of ethylene converted in each reactor is monitored. The term Q^{R1} referred to the percent of the ethylene added to R1 that was converted into a first ethylene interpolymer by the catalyst formulation. Similarly, Q^{R2} and Q^{R3} represented the percent of the ethylene added to R2 and residual ethylene flown into R3 from R1 and R2 that were converted into the second and third ethylene interpolymer, respectively.

In Tables 1A-1C, the term Q^{T} represented the total or overall ethylene conversion across the entire continuous solution polymerization plant; i.e., Q^{T}=100×[weight of ethylene in the interpolymer product]/([weight of ethylene in the interpolymer product]+[weight of unreacted ethylene]).

In Examples 1-13, the following single site catalyst components were used to prepare the first ethylene interpolymer in the first reactor (R1) configured in series to the second reactor (R2) and the third reactor (R3): component A, diphenylmethylene(cyclopentadienyl)(2,7-di-t-butylfuorenyl)hafnium dimethide [(2,7-tBu₂Flu)Ph₂C(Cp)HfMe₂]; component M, methylaluminoxane (MMAO-07); component B, trityl tetrakis(pentafluoro-phenyl)borate (trityl borate); and component P, 2,6-di-tert-butyl-4-ethylphenol (BHEB). Methylaluminoxane (MMAO-07); and 2,6-di-tert-butyl-4-ethylphenol are premixed in-line and then combined with diphenylmethylene(cyclopentadienyl)(2,7-di-t-butylfuorenyl)hafnium dimethide and trityl tetrakis(pentafluoro-phenyl)borate just before entering the polymerization reactor (R1). The following catalyst component solvents were used: methylpentane for components M and P; and xylene for component A and B. The efficiency of the single site catalyst formulation was optimized by adjusting the quantity of component A added to R1 [R1 catalyst (ppm) as recited in Tables 1A-1C], the mole ratios of the catalyst components—i.e., [M]/[A], [P]/[M] and [B]/[A] as tabulated in Tables 1A-1C- and the R1 catalyst inlet temperature (not shown in Tables 1A-1C). The R1 catalyst inlet temperature was controlled at a temperature between 20-40° C.

In Examples 1-13, an in-line Ziegler-Natta catalyst formulation catalyst was used to prepare the second ethylene interpolymer in the second reactor (R2). The in-line Ziegler-Natta catalyst formulation had the following components: butyl ethyl magnesium [component v]; tertiary butyl chloride [component vi]; titanium tetrachloride [component vii]; diethyl aluminum ethoxide [component viii]; and triethyl aluminum [component ix]. Methylpentane was used as the catalyst component solvent and the in-line Ziegler-Natta catalyst formulation was prepared using the following steps and then injected into the second reactor (R2). In step one, a solution of triethylaluminum and butyl ethyl magnesium (Mg:Al=20, mol:mol) was combined with a solution of tertiary butyl chloride and allowed to react for about 30 seconds to produce a MgCl₂ support. In step two, a solution of titanium tetrachloride was added to the mixture formed in step one and allowed to react for about 14 seconds prior to injection into second reactor (R2). The in-line Ziegler-Natta catalyst was activated in the reactor by injecting a solution of diethyl aluminum ethoxide into R2. The efficiency of the in-line Ziegler-Natta catalyst formulation was optimized by adjusting the quantity of titanium tetrachloride added to the reactor-recited as R2 catalyst (ppm) in Tables 1A-1C, the mole ratios of the catalyst components i.e., [vi]/[v], [viii]/[vii] and [ix]/[vii] as tabulated in Tables 1A-1C- and R2 catalyst inlet temperature (not shown in Tables 1A-1C). The R2 catalyst inlet temperature was controlled at a temperature between 20-40° C.

In Examples 1-13, no fresh ethylene, 1-octene, hydrogen and catalyst were pumped into the third reactor. The residual ethylene, residual 1-octene and residual active catalyst(s) entering the third reactor (R3), from upstream reactors R1 and R2, formed the third ethylene interpolymer in these Examples.

Polymerization in the continuous solution polymerization process was terminated by adding a catalyst deactivator to the third reactor exit stream. A multi-stage phase separation process was employed to recover the ethylene interpolymer product from the process solvent in which the third reactor exit stream was heated and passed through multiple V/L separators configured in series with one another. The polymer-rich stream exiting the last V/L separator, which contained from 94.5 to 96.5 weight percent of the ethylene interpolymer product, was fed to a twin-screw extruder for addition of additives and pelletization.

Examples 1-13 were made under process conditions to produce multicomponent ethylene interpolymer products which contained detectable levels of long chain branching as evidenced by a long chain branching factor (LCBF) of ≥0.005. The ethylene interpolymer products in Examples 1-13 are further characterized by a sum of unsaturation SUM^{u} of ≥0.047 per 100 carbons (see Table 4).

The multicomponent ethylene interpolymer products prepared in Examples 3-13 included a first fraction and a second fraction with distinct non-comonomer index distribution characteristics. The weight percent, molecular weight distribution index M_{w}/Mₙ and non-comonomer index distribution of the first and second fractions were determined by deconvolution of the experimentally measured molecular weight distribution and non-comonomer index distribution (NCIDᵢ) of the ethylene interpolymer product via the deconvolution scheme described in eq.(13) through eq.(15).

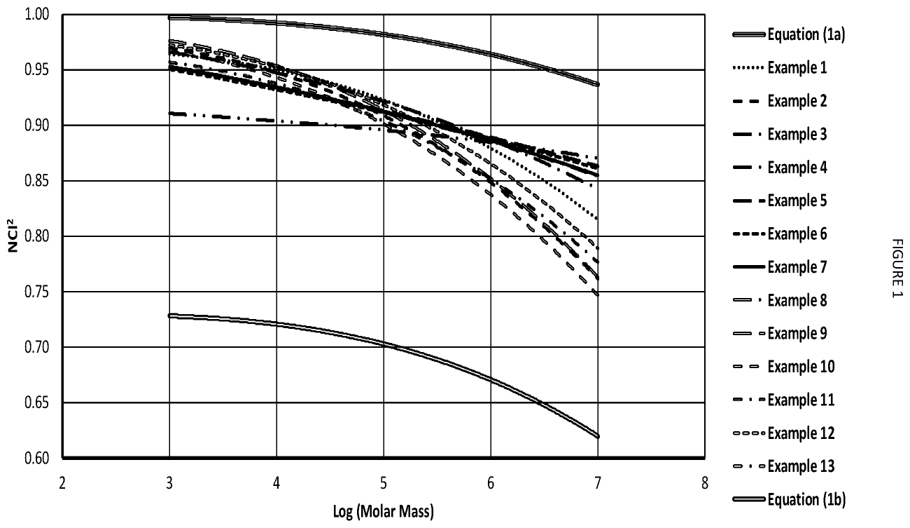

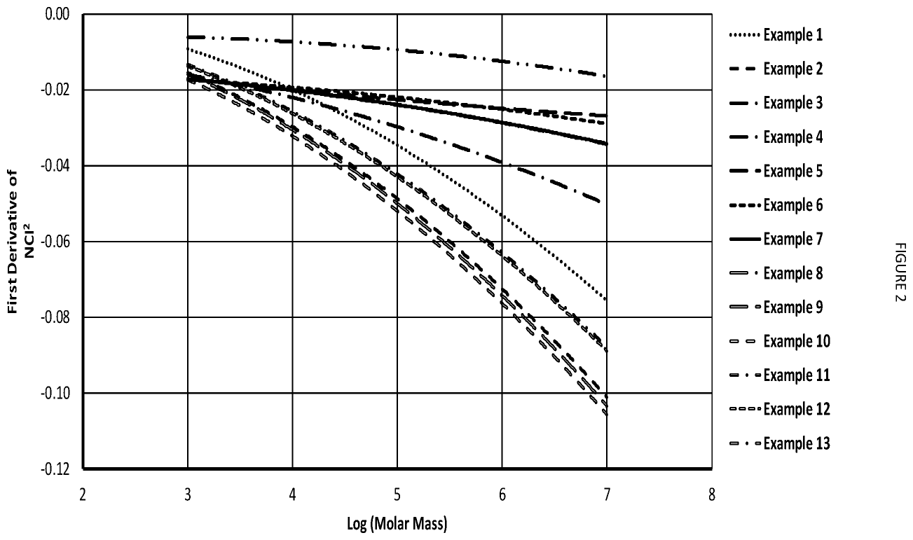

Example 1 contained 40 wt. % of a first fraction having a M_{w}/Mₙ of 1.99 and 60 wt. % of a second fraction having a M_{w}/Mₙ of 2.11. The second fraction in Example 1 was characterized according to a deconvoluted NCIDᵢ² which monotonically decreased as incremental molar mass Mᵢ increased. As shown in FIG. 1 and FIG. 2, the deconvoluted NCIDᵢ² values in Example 1 varied within the range defined by the inequality eq.(1b) <NCIDᵢ²<eq.(1a) and the first semi-log derivative of NCIDᵢ² (d NCIDᵢ²/d log Mᵢ) was less than or equal to −0.0001. The NCIDᵢ² of the second fraction was defined by eq.(3) in which β₀, β₁, β₂, β₃ and M₀ were 0.970, -0.0005, 0.0015, -0.00065 and 80000, respectively. The first fraction in Example 1 had a constant NCIDᵢⁱ value of 0.980 and a first semi-log derivative of NCIDᵢ^{I} of zero.

Example 2 contained 38 wt. % of a first fraction having a M_{w}/Mₙ of 3.24 and 62 wt. % of a second fraction having a M_{w}/Mₙ of 2.16. The second fraction in Example 2 was characterized according to a deconvoluted NCIDᵢ² which monotonically decreased as incremental molar mass Mᵢ increased. As shown in FIG. 1 and FIG. 2, the deconvoluted NCIDᵢ² values in Example 2 varied within the range defined by the inequality eq.(1b) <NCIDᵢ²<eq.(1a) and the first semi-log derivative of NCIDᵢ² (d NCIDᵢ²/d log Mᵢ) was less than or equal to −0.0001. The NCIDᵢ² of the second fraction was defined by eq.(3) in which β₀, β₁, β₂, β₃ and M₀ were 0.985, -0.002, 0.0015, -0.0008 and 70000, respectively. The first fraction in Example 2 had a constant NCIDᵢⁱ value of 0.980 and a first semi-log derivative of NCIDᵢ^{I} of zero.

Example 3 contained 40 wt. % of a first fraction having a M_{w}/Mₙ of 3.90 and 60 wt. % of a second fraction having a M_{w}/Mₙ of 2.03. The second fraction in Example 3 was characterized according to a deconvoluted NCIDᵢ² which monotonically decreased as incremental molar mass Mᵢ increased. As shown in FIG. 1 and FIG. 2, the deconvoluted NCIDᵢ² values in Example 3 varied within the range defined by the inequality eq.(1b) <NCIDᵢ²<eq.(1a) and the first semi-log derivative of NCIDᵢ² (d NCIDᵢ²/d log Mᵢ) was less than or equal to −0.0001. The NCIDᵢ² of the second fraction was defined by eq.(3) in which β₀, β₁, β₂, β₃ and M₀ were 0.930, -0.008, 0.001, -0.00015 and 70000, respectively. The first fraction in Example 3 had a constant NCIDᵢⁱ value of 0.980 and a first semi-log derivative of NCIDᵢ^{I} of zero.

Example 4 contained 38 wt. % of a first fraction having a M_{w}/Mₙ of 3.22 and 62 wt. % of a second fraction having a M_{w}/Mₙ of 2.31. The second fraction in Example 4 was characterized according to a deconvoluted NCIDᵢ² which monotonically decreased as incremental molar mass Mᵢ increased. As shown in FIG. 1 and FIG. 2, the deconvoluted NCIDᵢ² values in Example 4 varied within the range defined by the inequality eq.(1b) <NCIDᵢ²<eq.(1a) and the first semi-log derivative of NCIDᵢ² (d NCIDᵢ²/d log Mᵢ) was less than or equal to −0.0001. The NCIDᵢ² of the second fraction was defined by eq.(3) in which β₀, β₁, β₂, β₃ and M₀ were 1.020, -0.002, 0.0002, -0.0001 and 58000, respectively. The first fraction in Example 4 had a constant NCIDᵢⁱ value of 0.980 and a first semi-log derivative of NCIDᵢ^{I} of zero.

Example 5 contained 42 wt. % of a first fraction having a M_{w}/Mₙ of 3.21 and 58 wt. % of a second fraction having a M_{w}/Mₙ of 2.03. The second fraction in Example 5 was characterized according to a deconvoluted NCIDᵢ² which monotonically decreased as incremental molar mass Mᵢ increased. As shown in FIG. 1 and FIG. 2, the deconvoluted NCIDᵢ² values in Example 5 varied within the range defined by the inequality eq.(1b) <NCIDᵢ²<eq.(1a) and the first semi-log derivative of NCIDᵢ² (d NCIDᵢ²/d log Mᵢ) was less than or equal to −0.0001. The NCIDᵢ² of the second fraction was defined by eq.(3) in which β₀, β₁, β₂, β₃ and M₀ were 0.990, -0.006, -0.002, 0.00005 and 60000, respectively. The first fraction in Example 5 had a constant NCIDᵢ^{I} value of 0.965 and a first semi-log derivative of NCIDᵢ^{I} of zero.

Example 6 contained 40 wt. % of a first fraction having a M_{w}/Mₙ of 3.26 and 60 wt. % of a second fraction having a M_{w}/Mₙ of 2.31. The second fraction in Example 6 was characterized according to a deconvoluted NCIDᵢ² which monotonically decreased as incremental molar mass Mᵢ increased. As shown in FIG. 1 and FIG. 2, the deconvoluted NCIDᵢ² values in Example 6 varied within the range defined by the inequality eq.(1b) <NCIDᵢ²<eq.(1a) and the first semi-log derivative of NCIDᵢ² (d NCIDᵢ²/d log Mᵢ) was less than or equal to −0.0001. The NCIDᵢ² of the second fraction was defined by eq.(3) in which β₀, β₁, β₂, β₃ and M₀ were 1.000, -0.015, 0.0001, -0.0001 and 58000, respectively. The first fraction in Example 6 had a constant NCIDᵢⁱ value of 0.965 and a first semi-log derivative of NCIDᵢ^{I} of zero.

Example 7 contained 38 wt. % of a first fraction having a M_{w}/Mₙ of 2.75 and 62 wt. % of a second fraction having a M_{w}/Mₙ of 2.16. The second fraction in Example 7 was characterized according to a deconvoluted NCIDᵢ² which monotonically decreased as incremental molar mass Mᵢ increased. As shown in FIG. 1 and FIG. 2, the deconvoluted NCIDᵢ² values in Example 7 varied within the range defined by the inequality eq.(1b) <NCIDᵢ²<eq.(1a) and the first semi-log derivative of NCIDᵢ² (d NCIDᵢ²/d log Mᵢ) was less than or equal to −0.0001. The NCIDᵢ² of the second fraction was defined by eq.(3) in which β₀, β₁, β₂, β₃ and M₀ were 1.000, -0.014, 0.0002, -0.00015 and 58000, respectively. The first fraction in Example 7 had a constant NCIDᵢⁱ value of 0.960 and a first semi-log derivative of NCIDᵢ^{I} of zero.

Example 8 contained 40 wt. % of a first fraction having a M_{w}/Mₙ of 2.75 and 60 wt. % of a second fraction having a M_{w}/Mₙ of 2.38. The second fraction in Example 8 was characterized according to a deconvoluted NCIDᵢ² which monotonically decreased as incremental molar mass Mᵢ increased. As shown in FIG. 1 and FIG. 2, the deconvoluted NCIDᵢ² values in Example 8 varied within the range defined by the inequality eq.(1b) <NCIDᵢ²<eq.(1a) and the first semi-log derivative of NCIDᵢ² (d NCIDᵢ²/d log Mᵢ) was less than or equal to −0.0001. The NCIDᵢ² of the second fraction was defined by eq.(3) in which β₀, β₁, β₂, β₃ and M₀ were 1.000, -0.014, 0.0002, -0.00015 and 55000, respectively. The first fraction in Example 8 had a constant NCIDᵢ^{I} value of 0.960 and a first semi-log derivative of NCIDᵢ^{I} of zero.

Example 9 contained 40 wt. % of a first fraction having a M_{w}/Mₙ of 3.93 and 60 wt. % of a second fraction having a M_{w}/Mₙ of 2.03. The second fraction in Example 9 was characterized according to a deconvoluted NCIDᵢ² which monotonically decreased as incremental molar mass Mᵢ increased. As shown in FIG. 1 and FIG. 2, the deconvoluted NCIDᵢ² values in Example 9 varied within the range defined by the inequality eq.(1b) <NCIDᵢ²<eq.(1a) and the first semi-log derivative of NCIDᵢ² (d NCIDᵢ²/d log Mᵢ) was less than or equal to −0.0001. The NCIDᵢ² of the second fraction was defined by eq.(3) in which β₀, β₁, β₂, β₃ and M₀ were 0.990, -0.001, 0.0015, -0.0008 and 55000, respectively. The first fraction in Example 9 had a constant NCIDᵢ^{I} value of 0.980 and a first semi-log derivative of NCIDᵢ^{I} of zero.

Example 10 contained 40 wt. % of a first fraction having a M_{w}/Mₙ of 3.26 and 60 wt. % of a second fraction having a M_{w}/Mₙ of 2.31. The second fraction in Example 10 was characterized according to a deconvoluted NCIDᵢ² which monotonically decreased as incremental molar mass Mᵢ increased. As shown in FIG. 1 and FIG. 2, the deconvoluted NCIDᵢ² values in Example 10 varied within the range defined by the inequality eq.(1b) <NCIDᵢ²<eq.(1a) and the first semi-log derivative of NCIDᵢ² (d NCIDᵢ²/d log Mᵢ) was less than or equal to −0.0001. The NCIDᵢ² of the second fraction was defined by eq.(3) in which β₀, β₁, β₂, β₃ and M₀ were 0.985, -0.002, 0.0015, -0.0008 and 50000, respectively. The first fraction in Example 10 had a constant NCIDᵢⁱ value of 0.980 and a first semi-log derivative of NCIDᵢ^{I} of zero.

Example 11 contained 38 wt. % of a first fraction having a M_{w}/Mₙ of 3.26 and 62 wt. % of a second fraction having a M_{w}/Mₙ of 2.31. The second fraction in Example 11 was characterized according to a deconvoluted NCIDᵢ² which monotonically decreased as incremental molar mass Mᵢ increased. As shown in FIG. 1 and FIG. 2, the deconvoluted NCIDᵢ² values in Example 11 varied within the range defined by the inequality eq.(1b) <NCIDᵢ²<eq.(1a) and the first semi-log derivative of NCIDᵢ² (d NCIDᵢ²/d log Mᵢ) was less than or equal to −0.0001. The NCIDᵢ² of the second fraction was defined by eq.(3) in which β₀, β₁, β₂, β₃ and M₀ were 0.970, -0.002, 0.0015, -0.0007 and 60000, respectively. The first fraction in Example 11 had a constant NCIDᵢⁱ value of 0.975 and a first semi-log derivative of NCIDᵢ^{I} of zero.

Example 12 contained 40 wt. % of a first fraction having a M_{w}/Mₙ of 3.26 and 60 wt. % of a second fraction having a M_{w}/Mₙ of 2.31. The second fraction in Example 12 was characterized according to a deconvoluted NCIDᵢ² which monotonically decreased as incremental molar mass Mᵢ increased. As shown in FIG. 1 and FIG. 2, the deconvoluted NCIDᵢ² values in Example 12 varied within the range defined by the inequality eq.(1b) <NCIDᵢ²<eq.(1a) and the first semi-log derivative of NCIDᵢ² (d NCIDᵢ²/d log Mᵢ) was less than or equal to −0.0001. The NCIDᵢ² of the second fraction was defined by eq.(3) in which β₀, β₁, β₂, β₃ and M₀ were 0.986, -0.002, 0.0015, -0.0007 and 55000, respectively. The first fraction in Example 12 had a constant NCIDᵢ^{I} value of 0.980 and a first semi-log derivative of NCIDᵢ^{I} of zero.

Example 13 contained 45 wt. % of a first fraction having a M_{w}/Mₙ of 2.75 and 55 wt. % of a second fraction having a M_{w}/Mₙ of 2.31. The second fraction in Example 13 was characterized according to a deconvoluted NCIDᵢ² which monotonically decreased as incremental molar mass Mᵢ increased. As shown in FIG. 1 and FIG. 2, the deconvoluted NCIDᵢ² values in Example 13 varied within the range defined by the inequality eq.(1b) <NCIDᵢ²<eq.(1a) and the first semi-log derivative of NCIDᵢ² (d NCIDᵢ²/d log Mᵢ) was less than or equal to −0.0001. The NCIDᵢ² of the second fraction was defined by eq.(3) in which β₀, β₁, β₂, β₃ and M₀ were 1.000, -0.014, 0.0002, -0.00015 and 58000, respectively. The first fraction in Example 13 had a constant NCIDᵢⁱ value of 0.965 and a first semi-log derivative of NCIDᵢⁱ of zero.

The properties of the inventive ethylene interpolymer products (Examples 1-13) as well as those for several comparative resins (Comparative Examples 1-20) are shown in Tables 2A-2E and Tables 3.

Comparative Example 1 was DOWLEX® 2045G, a resin commercially available from The Dow Chemical Company. DOWLEX 2045G had a density of 0.920 g/cm³ and a melt index I₂ of 1.0 dg/min and was believed to be produced in a competitive solution-phase polymerization process using a comparative Ziegler-Natta catalyst. Comparative Example 1 had a non-comonomer index distribution NCIDᵢ which when plotted as a function of log (Mᵢ) yielded a flat curve—i.e., d(NCIDᵢ)/d log Mᵢ=0—with a mean NCIDᵢ value of 0.998. Comparative Example 1 had a LCBF value of 7.23×10⁻⁶ (dimensionless) and a SUM^{u} of 0.052 per 100 carbon atoms.

Comparative Example 2 was SURPASS® FPs117-C, a resin commercially available from the NOVA Chemicals Corporation. SURPASS FPs117-A has a density of 0.917 g/cm3 and a melt index I₂ of 1.0 dg/min. Comparative Example 2 was produced in a dual reactor solution polymerization process using a phosphinimine single site catalyst in which a first reactor and a second reactor are configured in series with one another. The NCIDᵢ of Comparative Example 2 was characterized by a flat curve—i.e., d(NCIDᵢ)/d log Mᵢ=0 having a mean value of 0.998. Comparative Example 2 had a LCBF value of 4.00×10⁻⁴ (dimensionless) and a SUM^{u} of 0.050 per 100 carbon atoms.

Comparative Example 3 was AFFINITY® PL 1880G, a resin commercially available from The Dow Chemical Company. AFFINITY PL 1880G had a density of 0.902 g/cm³ and a melt index I₂ of 1.0 dg/min and was believed to be produced in a single-reactor solution-phase polymerization process using a single site catalyst. The NCIDᵢ of Comparative Example 3 was best characterized by a flat curve—i.e., d(NCIDᵢ)/d log Mᵢ=0—having a mean value of 0.944. Comparative Example 3 had a LCBF value of 4.06×10⁻² (dimensionless) and a SUM^{u} of 0.021 per 100 carbon atoms.

Comparative Example 4 was Example 2 of U.S. Pat. Appl. Pub. No. 2019/0135958, an ethylene/1-octene interpolymer product made in a pilot scale dual reactor solution polymerization process using the above described single site catalyst components.

Comparative Example 4 has a density of about 0.9069 g/cm³ and a melt index I₂ of about 1.10 dg/min. The NCIDᵢ of Comparative Example 4 was best characterized by a flat curve i.e., d(NCIDᵢ)/d log Mᵢ=0—having a mean value of 0.975, and thus not deconvolutable into first and second fractions with distinct non-comonomer index distributions. Comparative Example 4 had a LCBF value of 5.63×10⁻²(dimensionless) and a SUM^{u} of 0.046 per 100 carbon atoms.

Comparative Example 5 was ELITE® 5100G, a resin commercially available from The Dow Chemical Company. ELITE 5100 G had a density of 0.920 g/cm³ and a melt index I₂ of 0.85 dg/min. Comparative Example 5 included 44 wt. % of a first fraction having a M_{w}/Mₙ of 4.01 and 56 wt. % of a second fraction having a M_{w}/Mₙ of 2.03. The non-comonomer index distribution of the first and second fraction (NCIDᵢ¹ and NCIDᵢ²) in this Comparative Example were best characterized by first and second flat curves—i.e., d(NCIDᵢ¹)/d log Mᵢ and d(NCIDᵢ²)/d log Mᵢ=0 having a mean value of 0.960 and 1.000, respectively. Comparative Example 5 had a LCBF value of 8.83×10⁻³ (dimensionless) and a SUM^{u} of 0.031 per 100 carbon atoms.

Comparative Example 6 is Example 5 of U.S. Pat. Appl. Pub. No. 2020/0216645. Comparative Example 6 has a density of 0.916 g/cm³ and a melt index I₂ of 1.00 dg/min. Comparative Example 6 is an ethylene/1-octene interpolymer product made using a phosphinimine single site catalyst and the above described in-line Ziegler-Natta catalyst components in a pilot scale dual reactor solution polymerization process in which a first reactor and a second reactor are configured in series with one another. Comparative Example 6 included 44 wt. % of a first fraction having a M_{w}/Mₙ of 5.63 and 56 wt. % of a second fraction having a M_{w}/Mₙ of 2.38. The non-comonomer index distribution of the first fraction (NCIDᵢ¹) was best characterized by a flat curve—i.e., d(NCIDᵢ¹)/d log Mᵢ=0 having a constant value of 0.997. The non-comonomer index distribution (NCIDᵢ²) of the second fraction in this Comparative Example was characterized by a monotonically decreasing curve when plotted as a function of log Mᵢ. The NCIDᵢ² in this Comparative further met the inequalities eq.(1a)<NCIDᵢ²<eq.(1b) and d(NCIDᵢ²)/d log Mᵢ<−0.0001. Comparative Example 6 had a LCBF value of 5.47×10⁻⁴ and a SUM^{u} of 0.071 per 100 carbon atoms.

Comparative Example 7 is SURPASS® VPsK914-A, a resin commercially available from the NOVA Chemicals Corporation. SURPASS VPsK914-A has a density of 0.913 g/cm³ and a melt index I₂ of 0.85. Comparative Example 7 included 55 wt. % of a first fraction having a M_{w}/Mₙ of 2.16 and 45 wt. % of a second fraction having a M_{w}/Mₙ of 2.08.

Characteristics of the non-comonomer index distribution of the first and second fractions (NCIDᵢ¹ and NCIDᵢ²) were similar to Comparative Example 6. Comparative Example 7 had a LCBF value of 6.58×10⁻⁵ (dimensionless) and a SUM^{u} of 0.048 per 100 carbon atoms.

Comparative Example 8 is SURPASS® SPsK919-F, a resin commercially available from the NOVA Chemicals Corporation. SURPASS SPsK919-F has a density of 0.919 g/cm³ and a melt index I₂ of 0.85. Comparative Example 8 included 50 wt. % of a first fraction having a M_{w}/Mₙ of 2.16 and 50 wt. % of a second fraction having a M_{w}/Mₙ of 2.03. Characteristics of the non-comonomer index distribution of the first and second fractions (NCIDᵢ¹ and NCIDᵢ²) in this Comparative Example were similar to Comparative Example 6. Comparative Example 8 had a LCBF value of 6.06×10⁻⁵ (dimensionless) and a SUM^{u} of 0.041 per 100 carbon atoms.

Comparative Example 9 was INNATE® ST50, a resin commercially available from The Dow Chemical Company. INNATE ST50 had a density of 0.918 g/cm³ and a melt index I₂ of 0.85 dg/min. Comparative Example 9 included 54 wt. % of a first fraction having a M_{w}/Mₙ of 3.98 and 46 wt. % of a second fraction having a M_{w}/Mₙ of 2.16. The non-comonomer index distribution index of the first fraction NCIDᵢⁱ was best represented by a flat curve—i.e., d(NCIDᵢ¹)/d log Mᵢ=0—having a constant value of 0.930. The second fraction in this Comparative Example had a non-comonomer index distribution NCIDᵢ² which had a constant value of 1.000 across the entire range of log Mᵢ. Comparative Example 9 had a LCBF value of 6.21×10⁻³ (dimensionless) and a SUM^{u} of 0.024 per 100 carbon atoms.

Comparative Example 10 was Example 4 of U.S. Pat. Appl. Pub. No. 2018/0305531. Comparative Example 10 had a density of 0.917 g/cm³ and a melt index I₂ of 0.70 dg/min. Comparative Example 11 was Example 3 of U.S. Pat. Appl. Pub. No. 2018/0305531. Comparative Example 11 had a density of 0.9177 g/cm³ and a melt index I₂ of 0.92 dg/min. Comparative Examples 10 and 11 were ethylene/1-octene interpolymer products made using the above described single site catalyst components and in-line Ziegler-Natta catalyst components in a pilot scale dual reactor solution polymerization process in which a first reactor and a second reactor were configured in series with one another.

Comparative Examples 10 included 50 wt. % of a first fraction having a M_{w}/Mₙ of 1.37 and 50 wt. % of a second fraction having a M_{w}/Mₙ of 1.82. The first fraction had a non-comonomer index distribution index NCIDᵢⁱ which was best represented by a flat curve i.e., d(NCIDᵢ¹)/d log Mᵢ=0—having a constant value of 0.970. The second fraction in this Comparative Example had a non-comonomer index distribution NCIDᵢ² which satisfied the inequalities in equations (1a), (1b) and d(NCIDᵢ²)/d log Mᵢ<−0.0001. Comparative Example 10 had a LCBF of 2.91×10⁻² (dimensionless) and a SUM^{u} of 0.034 per 100 carbon atoms.

Comparative Examples 11 included 60 wt. % of a first fraction having a M_{w}/Mₙ of 2.71 and 40 wt. % of a second fraction having a M_{w}/Mₙ of 2.69. The first fraction had α-non-comonomer index distribution index NCIDᵢ^{I} which was best represented by a flat curve i.e., d(NCIDᵢ¹)/d log Mᵢ=0—having a constant value of 0.940. The second fraction in this Comparative Example had a non-comonomer index distribution NCIDᵢ² which satisfied the inequalities in equations (1a), (1b) and d(NCIDᵢ²)/d log Mᵢ<−0.0001. Comparative Example 11 had a LCBF of 2.05×10⁻² (dimensionless) and a SUM^{u} of 0.039 per 100 carbon atoms.

Comparative Example 12 was Example 1 of U.S. Pat. Appl. Pub. No. 2018/0305531. Comparative Example 12 had a density of 0.9178 g/cm³ and a melt index I₂ of 1.07 dg/min. Comparative Example 13 was Example 2 of U.S. Pat. Appl. Pub. No. 2018/0305531. Comparative Example 13 had a density of 0.9170 g/cm³ and a melt index I₂ of 0.99 dg/min. Comparative Examples 12 and 13 were ethylene/1-octene interpolymer products made using the above described single site catalyst components and in-line Ziegler-Natta catalyst components in a pilot scale dual reactor solution polymerization process in which a first reactor and a second reactor were configured in series with one another.

Comparative Examples 12 included 40 wt. % of a first fraction having a M_{w}/Mₙ of 3.79 and 60 wt. % of a second fraction having a M_{w}/Mₙ of 2.31. The first fraction had a non-comonomer index distribution index NCIDᵢⁱ which was best represented by a flat curve i.e., d(NCIDᵢ¹)/d log Mᵢ=0—having a constant value of 0.950. The second fraction in this Comparative Example had a non-comonomer index distribution NCIDᵢ² which satisfied the inequalities in equations (1a), (1b) and d(NCIDᵢ²)/d log Mᵢ<−0.0001. Comparative Example 12 had a LCBF of 3.39×10⁻³ (dimensionless) and a SUM^{u} of 0.046 per 100 carbon atoms.

Comparative Examples 13 included 40 wt. % of a first fraction having a M_{w}/Mₙ of 3.14 and 60 wt. % of a second fraction having a M_{w}/Mₙ of 2.31. The first fraction had α-non-comonomer index distribution index NCIDᵢ^{I} which was best represented by a flat curve i.e., d(NCIDᵢ¹)/d log Mᵢ=0—having a constant value of 0.960. The second fraction in this Comparative Example had a non-comonomer index distribution NCIDᵢ² which satisfied the inequalities in equations (1a), (1b) and d(NCIDᵢ²)/d log Mᵢ<−0.0001. Comparative Example 13 had a LCBF of 9.94×10⁻³ (dimensionless) and a SUM^{u} of 0.045 per 100 carbon atoms.

Comparative Examples 16, 17 and 19 were Inventive Examples 3, 4 and 6 of U.S. Pat. Appl. Pub. No. 2021/0032450, respectively. Comparative Example 16 had a density of 0.9128 g/cm³ and a melt index I₂ of 0.84 dg/min. Comparative Example 17 had a density of 0.9123 g/cm³ and a melt index I₂ of 0.76 dg/min. Comparative Example 19 had a density of 0.9133 g/cm³ and a melt index I₂ of 3.56 dg/min. Comparative Examples 16, 17 and 19 were ethylene/1-octene interpolymer products made using the above described single site catalyst components and in-line Ziegler-Natta catalyst components in a pilot scale dual reactor solution polymerization process in which a first reactor and a second reactor were configured in series with one another.

Comparative Examples 16 included 50 wt. % of a first fraction having a M_{w}/Mₙ of 3.20 and 50 wt. % of a second fraction having a M_{w}/Mₙ of 2.03. The first fraction had a non-comonomer index distribution index NCIDᵢ^{I} which was best represented by a flat curve i.e., d(NCIDᵢ¹)/d log Mᵢ=0—having a constant value of 0.960. The second fraction in this Comparative Example had a non-comonomer index distribution NCIDᵢ² which satisfied the inequalities in equations (1a), (1b) and d(NCIDᵢ²)/d log Mᵢ<−0.0001. Comparative Example 16 had a LCBF of 1.17×10⁻³ (dimensionless) and a SUM^{u} of 0.036 per 100 carbon atoms.

Comparative Examples 17 included 50 wt. % of a first fraction having a M_{w}/Mₙ of 3.93 and 50 wt. % of a second fraction having a M_{w}/Mₙ of 2.03. The first fraction had α-non-comonomer index distribution index NCIDᵢ^{I} which was best represented by a flat curve i.e., d(NCIDᵢ¹)/d log Mᵢ=0—having a constant value of 0.960. The second fraction in this Comparative Example had a non-comonomer index distribution NCIDᵢ² which satisfied the inequalities in equations (1a), (1b) and d(NCIDᵢ²)/d log Mᵢ<−0.0001. Comparative Example 17 had a LCBF of 1.43×10⁻³ (dimensionless) and a SUM^{u} of 0.037 per 100 carbon atoms.

Comparative Examples 19 included 50 wt. % of a first fraction having a M_{w}/Mₙ of 3.70 and 50 wt. % of a second fraction having a M_{w}/Mₙ of 2.03. The first fraction had α-non-comonomer index distribution index NCIDᵢ^{I} which was best represented by a flat curve i.e., d(NCIDᵢ¹)/d log Mᵢ=0—having a constant value of 0.950. The second fraction in this Comparative Example had a non-comonomer index distribution NCIDᵢ² which satisfied the inequalities in equations (1a), (1b) and d(NCIDᵢ²)/d log Mᵢ<−0.0001. Comparative Example 19 had a LCBF of 2.66×10⁻⁴ (dimensionless) and a SUM^{u} of 0.056 per 100 carbon atoms.

Comparative Example 20 is Example 1 of U.S. Pat. Appl. Pub. No. 2020/0216645. Comparative Example 20 has a density of 0.9191 g/cm³ and a melt index I₂ of 0.9 dg/min. Comparative Example 20 is an ethylene/1-octene interpolymer product made using the above-described in-line Ziegler-Natta catalyst components in a pilot scale dual reactor solution polymerization process in which a first reactor and a second reactor are configured in series with one another. Comparative Example 20 had a non-comonomer index distribution NCIDᵢ which satisfied the inequalities in equations (1a), (1b) and a d(NCIDᵢ)/d log M of less than or equal to−0.0001. Comparative Example 20 had a LCBF value of 2.49×10⁻⁴ (dimensionless) and a SUM^{U} of 0.071 per 100 carbon atoms.

Details of the molecular weight characteristics of the ethylene interpolymer products components in Examples 1-13 and the multicomponent Comparative Examples: namely, the first and the second fractions, are provided in Tables 3A-3D. The first and second fractions properties shown in Tables 3A-3D were determined using a eq.(13):

$${NCID}_{i} = {\sum }_{i} {{x}^{1} ( {w}_{i} {M}_{i} )}^{1} {NCID}_{i}^{1} + {{x}^{2} ( {w}_{i} {M}_{i} )}^{2} {NCID}_{i}^{2} \qquad eq . ( 13 )$$

in which x¹ and x² represented the weight fractions of the first and second fractions, respectively—with the proviso that the sum of the weight fractions of the first and second fractions resulted in unity, i.e., x¹+x²=1. In eq.(13), (wᵢMᵢ)¹ was the weight fraction of the first fraction which had an incremental molecular weight of Mᵢ defined by a modified Flory-Schultz distribution according to eq.(14), NCIDᵢⁱ was the non-comonomer index distribution of the first fraction; (wᵢMᵢ)² was the weight fraction of the second fraction which had an incremental molecular weight Mᵢ defined by a log normal distribution according to eq.(15), and NCIDᵢ² was the non-comonomer index distribution of the second fraction. The modified Flory-Shultz distribution applied to the above-described calculations to deconvolute the non-comonomer index distribution of the first fraction NCIDᵢⁱ was defined as follows:

$${( {w}_{i} {M}_{i} )}^{A} = ln ( 10 ) \times ( \frac{{M}_{i}}{{M}_{r}} ) exp ( φ - \frac{{M}_{i}}{{M}_{r}} ) \qquad eq . ( 14 )$$

in which Mᵣ and φ were fitting parameters, i.e., Mᵣ was a reference molecular weight and φ was a breadth parameter. The log normal distribution was defined as follows:

$${( {w}_{i} {M}_{i} )}^{B} = \frac{1}{ξ {( 2 π )}^{\frac{1}{2}}} exp [ - ( \frac{1}{2} ) {( ( log {M}_{i} - log {M}_{o} ) / ξ )}^{2} ] \qquad eq . ( 15 )$$

where Mₒ and ξ were fitting parameters, i.e., Mₒ was the peak molecular weight of the second fraction and ξ was a breadth parameter.

TABLE 1A
Continuous Solution Process Operating Conditions: Examples 1-6.

| | Ex. 1 | Ex. 2 | Ex. 3 | Ex. 4 | Ex. 5 | Ex. 6 |
|---|---|---|---|---|---|---|
| Total Solution Rate^{overall} (Mg/h) | 400.1 | 400.1 | 400.0 | 395.3 | 359.9 | 360.0 |
| 1-Octene/ethylene^{overall} (wt/wt) | 0.665 | 0.577 | 0.665 | 0.560 | 0.788 | 0.724 |
| Q^{T} (%) | 94.3 | 94.0 | 94.1 | 94.0 | 94.3 | 94.4 |
| Polymer Production Rate (Mg/h) | 64.7 | 62.0 | 62.3 | 60.6 | 58.6 | 58.6 |
| ES^{R1} (%) | 45.0 | 45.0 | 45.0 | 45.0 | 45.0 | 45.0 |
| ES^{R2} (%) | 55.0 | 55.0 | 55.0 | 55.0 | 55.0 | 55.0 |
| ES^{R3} (%) | 0.0 | 0.0 | 0.0 | 0.0 | 0.0 | 0.0 |
| OS^{R1} (%) | 29.0 | 22.0 | 29.0 | 22.0 | 25.0 | 29.0 |
| OS^{R2} (%) | 71.0 | 78.0 | 71.0 | 78.0 | 75.0 | 71.0 |
| OS^{R3} (%) | 0.0 | 0.0 | 0.0 | 0.0 | 0.0 | 0.0 |
| Total Solution Rate^{R1} (Mg/h) | 212.9 | 203.2 | 205.5 | 199.2 | 188.2 | 190.6 |
| Ethylene Concentration in R1 (wt. %) | 12.62 | 13.15 | 12.61 | 13.15 | 12.78 | 12.62 |
| 1-Octene / ethylene in R1 Feed (wt/wt) | 0.425 | 0.278 | 0.425 | 0.265 | 0.437 | 0.464 |
| R1 Mean Temperature (° C.) | 166.0 | 170.0 | 166.0 | 169.9 | 167.5 | 94.4 |
| Q^{R1} (%) | 76.8 | 74.5 | 76.9 | 74.2 | 77.2 | 77.1 |
| H₂^{R1} (ppm) | 3.25 | 3.50 | 3.25 | 3.50 | 3.25 | 3.25 |
| R1 Catalyst (ppm) | 0.700 | 0.491 | 0.692 | 0.477 | 0.871 | 0.900 |
| R1 ([M]/[A]) mole ratio | 60.0 | 60.2 | 60.0 | 60.0 | 60.0 | 59.8 |
| R1 ([P]/[M]) mole ratio | 0.20 | 0.20 | 0.20 | 0.20 | 0.15 | 0.15 |
| R1 ([B]/[A]) mole ratio | 1.20 | 1.20 | 1.20 | 1.20 | 1.16 | 1.11 |
| Total Solution Rate^{R2} (Mg/h) | 394.7 | 394.8 | 394.5 | 389.9 | 354.6 | 354.7 |
| Ethylene Concentration in R2 (wt. %) | 15.13 | 15.05 | 14.60 | 14.93 | 15.07 | 15.07 |
| 1-Octene / ethylene in R2 Feed (wt/wt) | 0.857 | 0.816 | 0.856 | 0.791 | 1.074 | 0.934 |
| R2 Mean Temperature (° C.) | 200.0 | 205.1 | 200.0 | 204.3 | 200.0 | 200.0 |
| Q^{R2} (%) | 79.4 | 81.3 | 80.6 | 80.9 | 79.7 | 79.8 |
| H₂^{R2} (ppm) | 6.00 | 10.5 | 5.50 | 10.49 | 2.50 | 3.0 |
| R2 Catalyst (ppm) | 5.61 | 5.43 | 5.70 | 5.24 | 6.32 | 6.47 |
| R2 ([vi]/[v]) mole ratio | 1.35 | 1.35 | 1.35 | 1.35 | 1.45 | 1.45 |
| R2 ([viii]/[vii]) mole ratio | 1.87 | 1.87 | 1.87 | 1.87 | 2.00 | 2.00 |
| R2 ([ix]/[vii]) mole ratio | 0.37 | 0.37 | 0.37 | 0.37 | 0.37 | 0.37 |
| R3 Volume (L) | 7130 | 7130 | 7130 | 7130 | 7130 | 7130 |
| Total Solution Rate^{R3} (Mg/h) | 400.1 | 400.1 | 400.0 | 395.3 | 359.9 | 360.0 |
| Q^{R3} (%) | 68.8 | 68.1 | 71.4 | 67.7 | 78.4 | 79.6 |
| R3 Exit Temperature (° C.) | 217.8 | 222.3 | 216.8 | 221.6 | 218.1 | 218.1 |
| H₂^{R3} R3 (ppm) | 0.00 | 0.00 | 0.00 | 0.00 | 0.00 | 0.00 |

TABLE 1B
Continuous Solution Process Operating Conditions: Examples 7-12.

| | Ex. 7 | Ex. 8 | Ex. 9 | Ex. 10 | Ex. 11 | Ex. 12 |
|---|---|---|---|---|---|---|
| Total Solution Rate^{overall} (Mg/h) | 340.0 | 380.0 | 393.0 | 385.1 | 364.1 | 375.3 |
| 1-Octene/ethylene^{overall} (wt/wt) | 0.724 | 0.700 | 0.587 | 0.626 | 0.598 | 0.585 |
| Q^{T} (%) | 94.3 | 94.4 | 94.3 | 94.2 | 94.4 | 94.1 |
| Polymer Production Rate (Mg/h) | 55.1 | 61.9 | 61.3 | 63.4 | 59.5 | 61.3 |
| ES^{R1} (%) | 45.0 | 45.0 | 45.0 | 45.0 | 45.0 | 45.0 |
| ES^{R2} (%) | 55.0 | 55.0 | 55.0 | 55.0 | 55.0 | 55.0 |
| ES^{R3} (%) | 0.0 | 0.0 | 0.0 | 0.0 | 0.0 | 0.0 |
| OS^{R1} (%) | 29.0 | 29.0 | 22.0 | 22.0 | 22.0 | 22.0 |
| OS^{R2} (%) | 71.0 | 71.0 | 78.0 | 78.0 | 78.0 | 78.0 |
| OS^{R3} (%) | 0.0 | 0.0 | 0.0 | 0.0 | 0.0 | 0.0 |
| Total Solution Rate^{R1} (Mg/h) | 180.9 | 203.4 | 199.6 | 194.6 | 183.1 | 188.8 |
| Ethylene Concentration in R1 (wt. %) | 12.50 | 12.55 | 13.18 | 13.90 | 13.90 | 13.96 |
| 1-Octene / ethylene in R1 Feed (wt/wt) | 0.464 | 0.448 | 0.284 | 0.304 | 0.291 | 0.285 |
| R1 Mean Temperature (° C.) | 166.0 | 165.7 | 170.6 | 173.0 | 173.3 | 173.3 |
| Q^{R1} (%) | 77.9 | 77.4 | 75.0 | 74.7 | 75.4 | 75.1 |
| H₂^{R1} (ppm) | 3.20 | 3.20 | 3.50 | 3.50 | 3.49 | 3.50 |
| R1 Catalyst (ppm) | 0.886 | 0.798 | 0.526 | 0.537 | 0.431 | 0.423 |
| R1 ([M]/[A]) mole ratio | 60.1 | 39.9 | 40.0 | 40.1 | 40.4 | 40.0 |
| R1 ([P]/[M]) mole ratio | 0.15 | 0.20 | 0.20 | 0.20 | 0.15 | 0.16 |
| R1 ([B]/[A]) mole ratio | 1.19 | 1.17 | 1.20 | 1.20 | 1.20 | 1.20 |
| Total Solution Rate^{R2} (Mg/h) | 334.6 | 374.7 | 387.6 | 379.6 | 358.7 | 369.9 |
| Ethylene Concentration in R2 (wt. %) | 15.01 | 15.14 | 15.09 | 15.82 | 15.75 | 15.84 |
| 1-Octene / ethylene in R2 Feed (wt/wt) | 0.934 | 0.901 | 0.831 | 0.887 | 0.848 | 0.829 |
| R2 Mean Temperature (° C.) | 200.0 | 200.0 | 205.0 | 205.0 | 204.9 | 204.9 |
| Q^{R2} (%) | 79.9 | 79.6 | 80.0 | 79.9 | 79.1 | 78.7 |
| H₂^{R2} (ppm) | 2.50 | 2.00 | 6.00 | 6.00 | 5.47 | 6.00 |
| R2 Catalyst (ppm) | 6.23 | 5.72 | 5.52 | 5.53 | 4.24 | 4.28 |
| R2 ([vi]/[v]) mole ratio | 1.65 | 1.65 | 1.65 | 1.65 | 1.35 | 1.35 |
| R2 ([viii]/[vii]) mole ratio | 1.99 | 2.00 | 1.99 | 2.00 | 1.96 | 1.96 |
| R2 ([ix]/[vii]) mole ratio | 0.37 | 0.37 | 0.37 | 0.37 | 0.37 | 0.37 |
| R3 Volume (L) | 7130 | 7130 | 7130 | 7130 | 7130 | 7130 |
| Total Solution Rate^{R3} (Mg/h) | 340.0 | 380.0 | 393.0 | 385.1 | 364.1 | 375.3 |
| Q^{R3} (%) | 79.0 | 78.1 | 78.9 | 77.4 | 82.8 | 82.5 |
| R3 Exit Temperature (° C.) | 217.5 | 218.4 | 223.2 | 223.9 | 223.2 | 223.4 |
| H₂^{R3} (ppm) | 0.00 | 0.00 | 0.00 | 0.00 | 0.00 | 0.00 |

TABLE 1C
Continuous Solution Process Operating Conditions: Example 13.

| | Ex. 13 |
|---|---|
| Total Solution Rate^{overall} (Mg/h) | 382.6 |
| 1-Octene/ethylene^{overall} (wt/wt) | 0.650 |
| Q^{T} (%) | 94.4 |
| Polymer Production Rate (Mg/h) | 61.8 |
| ES^{R1} (%) | 44.8 |
| ES^{R2} (%) | 55.2 |
| ES^{R3} (%) | 0.0 |
| OS^{R1} (%) | 29.2 |
| OS^{R2} (%) | 70.8 |
| OS^{R3} (%) | 0.0 |
| Total Solution Rate^{R1} (Mg/h) | 202.4 |
| Ethylene Concentration in R1 (wt. %) | 12.66 |
| 1-Octene/ethylene in R1 Feed (wt/wt) | 0.424 |
| R1 Mean Temperature (° C.) | 166.2 |
| Q^{R1} (%) | 77.4 |
| H₂^{R1} (ppm) | 3.36 |
| R1 Catalyst (ppm) | 0.606 |
| R1 ([M]/[A]) mole ratio | 40.0 |
| R1 ([P]/[M]) mole ratio | 0.20 |
| R1 ([B]/[A]) mole ratio | 1.20 |
| Total Solution Rate^{R2} (Mg/h) | 377.2 |
| Ethylene Concentration in R2 (wt. %) | 15.16 |
| 1-Octene/ethylene in R2 feed (wt/wt) | 0.834 |
| R2 Mean Temperature (° C.) | 200.0 |
| Q^{R2} (%) | 78.3 |
| H₂^{R2} (ppm) | 2.00 |
| R2 Catalyst (ppm) | 4.53 |
| R2 ([vi]/[v]) mole ratio | 1.35 |
| R2 ([viii]/[vii]) mole ratio | 1.98 |
| R2 ([ix]/[vii]) mole ratio | 0.37 |
| R3 Volume (L) | 7130 |
| Total Solution Rate^{R3} (Mg/h) | 382.6 |
| Q^{R3} (%) | 82.4 |
| R3 Exit Temperature (° C.) | 218.0 |
| H₂^{R3} (ppm) | 0.00 |

TABLE 2A
Characterization of Ethylene Interpolymer Products: Examples 1-7

| | Ex. 1 | Ex. 2 | Ex. 3 | Ex. 4 | Ex. 5 | Ex. 6 | Ex. 7 |
|---|---|---|---|---|---|---|---|
| Density (g/cm³) | 0.9138 | 0.9187 | 0.9132 | 0.9191 | 0.9131 | 0.9137 | 0.9126 |
| I₂ (dg/min) | 0.78 | 0.75 | 0.79 | 0.75 | 0.83 | 0.85 | 0.95 |
| S. Ex. | 1.39 | 1.42 | 1.39 | 1.42 | 1.41 | 1.40 | 1.38 |
| I₂₁/I₂ | 30.8 | 34.2 | 31.3 | 33.8 | 32.7 | 32.3 | 31.6 |
| M_{w} (kg/mol) | 101.2 | 100.8 | 97.3 | 103.2 | 97.1 | 99.2 | 90.2 |
| M_{w}/Mₙ | 2.82 | 2.90 | 2.79 | 3.04 | 3.02 | 2.64 | 2.68 |
| M_{z}/M_{w} | 2.06 | 2.08 | 2.07 | 2.27 | 2.16 | 2.09 | 1.88 |
| BrF per 1000Cs | 17.6 | 13.5 | 17.8 | 13.5 | 18.6 | 18.5 | 18.6 |
| Mole % α-olefin | 3.5 | 2.7 | 3.6 | 2.7 | 3.7 | 3.7 | 3.7 |
| CDBI₅₀ (%) | 61.7 | 71.8 | 62.8 | 70.6 | 63.0 | 58.2 | 57.3 |
| CY-a | 0.2358 | 0.1935 | 0.2376 | 0.1943 | 0.2525 | 0.2510 | 0.2741 |
| τ (ms) | 28.3 | 29.9 | 27.4 | 29.3 | 31.4 | 30.9 | 26.7 |
| η₀ (kPa · s) | 32.2 | 55.1 | 30.5 | 53.7 | 26.9 | 27.3 | 19.8 |
| Melt Strength (cN) | 5.77 | 5.26 | 5.64 | 5.09 | 5.17 | 5.65 | 4.72 |

TABLE 2B
Characterization of Ethylene Interpolymer Products: Examples 8-13

| | Ex. 8 | Ex. 9 | Ex. 10 | Ex. 11 | Ex. 12 | Ex. 13 |
|---|---|---|---|---|---|---|
| Density (g/cm³) | 0.9149 | 0.9218 | 0.9188 | 0.9197 | 0.9206 | 0.9128 |
| I₂ (dg/min) | 0.83 | 0.80 | 0.81 | 0.81 | 0.80 | 0.71 |
| S. Ex. | 1.41 | 1.43 | 1.42 | 1.41 | 1.42 | 1.39 |
| I₂₁/I₂ | 32.7 | 34.4 | 34.2 | 32.8 | 33.6 | 31.2 |
| M_{w} (kg/mol) | 96.4 | 98.6 | 94.5 | 100.4 | 95.7 | 105.3 |
| M_{w}/Mₙ | 2.78 | 3.34 | 3.16 | 2.57 | 3.01 | 2.46 |
| M_{z}/M_{w} | 1.99 | 2.29 | 2.13 | 2.06 | 2.16 | 2.05 |
| BrF per 1000Cs | 18.2 | 13.2 | 14.4 | 14.2 | 13.7 | 17.7 |
| Mole % α-olefin | 3.6 | 2.6 | 2.9 | 2.8 | 2.7 | 3.5 |
| CDBI₅₀ (%) | 58.5 | 71.5 | 71.3 | 72.5 | 72.4 | 61.0 |
| CY-a | 0.2492 | 0.1989 | 0.2072 | 0.2080 | 0.1989 | 0.2411 |
| τ (ms) | 31.9 | 31.0 | 27.5 | 25.6 | 27.4 | 32.8 |
| η₀ (kPa · s) | 28.1 | 50.5 | 40.8 | 41.8 | 48.6 | 34.3 |
| Melt Strength (cN) | 5.69 | 5.20 | 5.20 | 5.07 | 5.00 | 6.03 |

TABLE 2C
Characterization of Comparative Ethylene Interpolymer
Products: Comparative Examples 1-7.

| | Comp. | Comp. | Comp. | Comp. | Comp. | Comp. | Comp. |
|---|---|---|---|---|---|---|---|
| | 1 | 2 | 3 | 4 | 5 | 6 | 7 |
| Density (g/cm³) | 0.9182 | 0.9162 | 0.9018 | 0.9028 | 0.9189 | 0.916 | 0.9124 |
| I₂ (dg/min) | 0.98 | 0.99 | 1.06 | 0.91 | 0.89 | 1 | 0.92 |
| S. Ex. | 1.31 | 1.27 | 1.41 | 1.44 | 1.36 | 1.26 | 1.25 |
| I₂₁/I₂ | 28.2 | 30.8 | 29.5 | 31.1 | 30.4 | 27.2 | 23.4 |
| M_{w} (kg/mol) | 94 | 102.6 | 83.2 | 84.3 | 110.9 | 105 | 107.5 |
| M_{w}/Mₙ | 3.52 | 3.08 | 2.07 | 1.87 | 2.62 | 3.66 | 2.51 |
| M_{z}/M_{w} | 2.61 | 2.32 | 1.79 | 1.93 | 2.14 | 2.4 | 2.14 |
| BrF per 1000Cs | 13.2 | 14.6 | 23.2 | 22.3 | 14.1 | 14.5 | 18.1 |
| Mole % α-olefin | 2.6 | 2.9 | 4.6 | 4.5 | 2.8 | 2.9 | 3.6 |
| CDBI₅₀ (%) | 54 | 77.5 | 89.5 | 92.5 | 24.5 | 51.4 | 59.7 |
| CY-a | 0.4229 | 0.5878 | 0.2513 | 0.2545 | 0.2791 | 0.6126 | 0.4487 |
| τ (ms) | 35.5 | 44.6 | 21.6 | 26.1 | 23.5 | 44.4 | 24.4 |
| η₀ (kPa · s) | 12.7 | 9.1 | 20.6 | 23.9 | 19.7 | 8.7 | 10.7 |
| Melt Strength (cN) | 3.24 | — | 3.43 | 3.89 | 4.07 | 2.69 | 3.99 |

TABLE 2D
Characterization of Comparative Ethylene Interpolymer
Products: Comparative Examples 8-13.

| | Comp. | Comp. | Comp. | Comp. | Comp. | Comp. |
|---|---|---|---|---|---|---|
| | 8 | 9 | 10 | 11 | 12 | 13 |
| Density (g/cm³) | 0.921 | 0.9179 | 0.917 | 0.9177 | 0.9178 | 0.917 |
| I₂ (dg/min) | 0.85 | 0.84 | 0.7 | 0.92 | 1.07 | 0.99 |
| S. Ex. | 1.23 | 1.32 | 1.4 | 1.38 | 1.33 | 1.32 |
| I₂₁/I₂ | 22.1 | 29.5 | 34.7 | 29.7 | 27.5 | 26.4 |
| M_{w} (kg/mol) | 111.6 | 104.7 | 106.3 | 93.3 | 100.1 | 100.5 |
| M_{w}/Mₙ | 2.82 | 2.96 | 2.99 | 2.99 | 3.03 | 2.4 |
| M_{z}/M_{w} | 2.5 | 2.09 | 2.05 | 1.73 | 2.66 | 2.09 |
| BrF per 1000Cs | 12.7 | 14.7 | 16.7 | 19.8 | 15.3 | 15.8 |
| Mole % α-olefin | 2.5 | 2.9 | 3.3 | 4 | 3.1 | 3.2 |
| CDBI₅₀ (%) | 51.9 | 43.4 | 49.8 | 57 | 38.4 | 37.3 |
| CY-a | 0.4806 | 0.3723 | 0.2479 | 0.2809 | 0.3666 | 0.3548 |
| τ (ms) | 24.3 | 33.2 | 43.3 | 23.6 | 22.5 | 21.5 |
| η₀ (kPa · s) | 11.1 | 15 | 35.1 | 19.3 | 11.4 | 12.5 |
| Melt Strength (cN) | 3.15 | 3.94 | 5.26 | 4.37 | 3.36 | 3.81 |

TABLE 2E
Characterization of Comparative Ethylene Interpolymer
Products: Comparative Examples 16, 17, 19 and 20.

| | Comp. 16 | Comp. 17 | Comp. 19 | Comp. 20 |
|---|---|---|---|---|
| Density (g/cm³) | 0.9128 | 0.9123 | 0.9133 | 0.9191 |
| I₂ (dg/min) | 0.84 | 0.76 | 3.56 | 0.9 |
| S. Ex. | 1.25 | 1.27 | 1.29 | 1.32 |
| I₂₁/I₂ | 23.6 | 23.7 | 24.6 | 29 |
| M_{w} (kg/mol) | 108.8 | 115.4 | 74.9 | 108.1 |
| M_{w}/Mₙ | 2.9 | 2.8 | 2.53 | 3.65 |
| M_{z}/M_{w} | 2.11 | 2.46 | 1.98 | 2.89 |
| BrF per 1000 Cs | 17.9 | 18.5 | 19.2 | 13.5 |
| Mole % α-olefin | 3.6 | 3.7 | 3.8 | 2.7 |
| CDBI₅₀ (%) | 69.6 | 64.8 | 67.4 | 51.4 |
| CY-a | 0.3981 | 0.3826 | 0.4735 | 0.4462 |
| τ (ms) | 24.4 | 25.9 | 7.5 | 33.9 |
| η₀ (kPa · s) | 13.3 | 14.6 | 2.8 | 11.2 |
| Melt Strength (cN) | 3.98 | 4.27 | 1.17 | — |

TABLE 3A
Deconvoluted Molecular Weight Characteristics of the First and Second Fractions: Examples 1-6

| | Ex. 1 | Ex. 2 | Ex. 3 | Ex. 4 | Ex. 5 | Ex. 6 |
|---|---|---|---|---|---|---|
| The First Fraction | | | | | | |
| weight fraction, x¹ (wt. %) | 40 | 38 | 40 | 38 | 42 | 40 |
| Mᵣ (g/mol) | 110000 | 150000 | 140000 | 140000 | 130000 | 160000 |
| φ | 1.500 | 1.100 | 1.000 | 1.100 | 1.100 | 1.100 |
| M_{w}¹ | 125065 | 139957 | 122952 | 130629 | 121300 | 149286 |
| M_{w}¹/Mₙ¹ | 1.99 | 3.24 | 3.90 | 3.22 | 3.21 | 3.26 |
| The Second Fraction | | | | | | |
| weight fraction, x² (wt. %) | 60 | 62 | 60 | 62 | 58 | 60 |
| Mₒ (g/mol) | 80000 | 70000 | 70000 | 58000 | 60000 | 58000 |
| ξ | 0.253 | 0.255 | 0.250 | 0.260 | 0.250 | 0.260 |
| M_{w}² | 116118 | 102889 | 99784 | 88148 | 85529 | 88148 |
| M_{w}²/Mₙ² | 2.11 | 2.16 | 2.03 | 2.31 | 2.03 | 2.31 |

TABLE 3B
Deconvoluted Molecular Weight Characteristics of the First and Second Fractions: Examples 7-12

| | Ex. 7 | Ex. 8 | Ex. 9 | Ex. 10 | Ex. 11 | Ex. 12 |
|---|---|---|---|---|---|---|
| The First Fraction | | | | | | |
| weight fraction, x¹ (wt. %) | 38 | 40 | 40 | 40 | 38 | 40 |
| Mᵣ (g/mol) | 140000 | 140000 | 150000 | 160000 | 160000 | 160000 |
| φ | 1.200 | 1.200 | 1.000 | 1.100 | 1.100 | 1.100 |
| M_{w}¹ | 138062 | 138062 | 131731 | 149286 | 149286 | 149286 |
| M_{w}¹/Mₙ¹ | 2.75 | 2.75 | 3.93 | 3.26 | 3.26 | 3.26 |
| The Second Fraction | | | | | | |
| weight fraction, x² (wt. %) | 62 | 60 | 60 | 60 | 62 | 60 |
| Mₒ (g/mol) | 58000 | 55000 | 55000 | 50000 | 60000 | 55000 |
| ξ | 0.255 | 0.262 | 0.250 | 0.260 | 0.260 | 0.260 |
| M_{w}² | 85251 | 84784 | 78402 | 75989 | 91187 | 83588 |
| M_{w}²/Mₙ² | 2.16 | 2.38 | 2.03 | 2.31 | 2.31 | 2.31 |

TABLE 3C
Deconvoluted Molecular Weight Characteristics of the First
and Second Fractions: Example 13, Comparative Example 5-10.

| | Ex. | Comp. | Comp. | Comp. | Comp. | Comp. | Comp. |
|---|---|---|---|---|---|---|---|
| | 13 | 5 | 6 | 7 | 8 | 9 | 10 |
| The First Fraction | | | | | | | |
| weight fraction, x¹ (wt. %) | 45 | 44 | 44 | 55 | 50 | 54 | 50 |
| Mᵣ (g/mol) | 140000 | 180000 | 160000 | 90000 | 95000 | 170000 | 120000 |
| φ | 1.200 | 1.100 | 0.85 | 1.4 | 1.4 | 1.000 | 2.600 |
| M_{w}¹ | 138062 | 158068 | 126736 | 97916 | 103355 | 149289 | 194692 |
| M_{w}¹/Mₙ¹ | 2.75 | 4.01 | 5.63 | 2.16 | 2.16 | 3.98 | 1.37 |
| The Second Fraction | | | | | | | |
| weight fraction, x² (wt. %) | 55 | 56 | 56 | 45 | 50 | 46 | 50 |
| Mₒ (g/mol) | 58000 | 50000 | 65000 | 85000 | 90000 | 50000 | 60000 |
| ξ | 0.260 | 0.250 | 0.262 | 0.252 | 0.25 | 0.255 | 0.240 |
| M_{w}² | 88148 | 71274 | 100200 | 122622 | 128294 | 73492 | 81030 |
| M_{w}²/Mₙ² | 2.31 | 2.03 | 2.38 | 2.08 | 2.03 | 2.16 | 1.82 |

TABLE 3D
Deconvoluted Molecular Weight Characteristics of the First and
Second Fractions: Comparative Examples 11-13, 16, 17 and 19.

| | Comp. | Comp. | Comp. | Comp. | Comp. | Comp. |
|---|---|---|---|---|---|---|
| | 11 | 12 | 13 | 16 | 17 | 19 |
| The First Fraction | | | | | | |
| weight fraction, x¹ (wt. %) | 60 | 40 | 40 | 50 | 50 | 50 |
| Mᵣ (g/mol) | 100000 | 110000 | 100000 | 125000 | 15000 | 90000 |
| φ | 1.200 | 1.000 | 1.100 | 1.100 | 1.000 | 1.000 |
| M_{w}¹ | 98620 | 96615 | 93313 | 116635 | 131731 | 79056 |
| M_{w}¹/Mₙ¹ | 2.71 | 3.79 | 3.14 | 3.20 | 3.93 | 3.70 |
| The Second Fraction | | | | | | |
| weight fraction, x² (wt. %) | 40 | 60 | 60 | 50 | 50 | 50 |
| Mₒ (g/mol) | 80000 | 70000 | 75000 | 55000 | 70000 | 45000 |
| ξ | 0.270 | 0.260 | 0.260 | 0.250 | 0.250 | 0.250 |
| M_{w}² | 131243 | 106385 | 113984 | 78402 | 99784 | 64147 |
| M_{w}²/Mₙ² | 2.69 | 2.31 | 2.31 | 2.03 | 2.03 | 2.03 |

TABLE 4
FTIR Unsaturation, the Sum of Unsaturation SUM^{u} and the
LCBF in Ethylene Interpolymer Products of the Present
Disclosure Relative to Comparative Ethylene Interpolymer
Products: Examples 1-13 and Comparative Examples 1-20.

| | Internal | Side Chain | Terminal | | |
|---|---|---|---|---|---|
| | Unsaturation | Unsaturation | Unsaturation | SUMU | LCBF |
| | Per 100 Cs | per 100 Cs | per 100 Cs | per 100 Cs | (—) |
| Ex. 1 | 0.006 | 0.005 | 0.031 | 0.048 | 2.21E−02 |
| Ex. 2 | 0.006 | 0.004 | 0.035 | 0.051 | 3.13E−02 |
| Ex. 3 | 0.006 | 0.006 | 0.032 | 0.050 | 2.07E−02 |
| Ex. 4 | 0.006 | 0.004 | 0.036 | 0.052 | 3.35E−02 |
| Ex. 5 | 0.007 | 0.009 | 0.035 | 0.058 | 2.04E−02 |
| Ex. 6 | 0.007 | 0.008 | 0.036 | 0.058 | 2.18E−02 |
| Ex. 7 | 0.007 | 0.009 | 0.036 | 0.059 | 1.69E−02 |
| Ex. 8 | 0.007 | 0.008 | 0.036 | 0.058 | 1.92E−02 |
| Ex. 9 | 0.003 | 0.006 | 0.039 | 0.051 | 3.45E−02 |
| Ex. 10 | 0.007 | 0.007 | 0.042 | 0.063 | 2.50E−02 |
| Ex. 11 | 0.004 | 0.008 | 0.038 | 0.054 | 1.93E−02 |
| Ex. 12 | 0.004 | 0.005 | 0.039 | 0.052 | 2.31E−02 |
| Ex. 13 | 0.007 | 0.009 | 0.033 | 0.056 | 1.67E−02 |
| Comp. Ex. 1 | 0.004 | 0.005 | 0.039 | 0.052 | 7.23E−06 |
| Comp. Ex. 2 | 0.021 | 0.002 | 0.006 | 0.050 | 4.00E−04 |
| Comp. Ex. 3 | 0.006 | 0.001 | 0.008 | 0.021 | 4.06E−02 |
| Comp. Ex. 4 | 0.014 | 0.009 | 0.009 | 0.046 | 5.63E−02 |
| Comp. Ex. 5 | 0.004 | 0.002 | 0.021 | 0.031 | 8.83E−03 |
| Comp. Ex. 6 | 0.009 | 0.005 | 0.048 | 0.071 | 5.47E−04 |
| Comp. Ex. 7 | 0.008 | 0.003 | 0.029 | 0.048 | 6.58E−05 |
| Comp. Ex. 8 | 0.004 | 0.003 | 0.030 | 0.041 | 6.06E−05 |
| Comp. Ex. 9 | 0.003 | 0.002 | 0.017 | 0.024 | 6.21E−03 |
| Comp. Ex. 10 | 0.004 | 0.001 | 0.025 | 0.034 | 2.91E−02 |
| Comp. Ex. 11 | 0.005 | 0.004 | 0.025 | 0.039 | 2.05E−02 |
| Comp. Ex. 12 | 0.006 | 0.005 | 0.029 | 0.046 | 3.39E−03 |
| Comp. Ex. 13 | 0.005 | 0.005 | 0.03 | 0.045 | 9.94E−03 |
| Comp. Ex. 16 | 0.005 | 0.000 | 0.026 | 0.036 | 1.17E−03 |
| Comp. Ex. 17 | 0.005 | 0.000 | 0.027 | 0.037 | 1.43E−03 |
| Comp. Ex. 19 | 0.007 | 0.006 | 0.036 | 0.056 | 2.66E−04 |
| Comp. Ex. 20 | 0.005 | 0.011 | 0.05 | 0.071 | 2.49E−04 |

### Monolayer Blown Films

With reference to Tables 2A-2E, it is understood that Example 1-13 contained LCB in amounts sufficient to intensify elasticity-related properties (e.g., an increased melt strength and zero-shear viscosity), and shear-thinning characteristics (e.g., a decreased CY-a or an increased I₂₁/I₂). These aspects enable resin compositions appropriate for processes such as film-blowing where a low pressure buildup during the extrusion step and bubble stability during the film blowing step is desired.

Monolayer blown films were produced on a monolayer blown film line (Gloucester Blown Film Line). This line was equipped with a Gloucester extruder, 2.5-inch (6.45 cm) barrel diameter, 24/1 L/D (barrel Length/barrel Diameter) equipped with: a barrier screw; a low pressure 4 inch (10.16 cm) diameter die with a 35 mil (0.089 cm) die gap, and; a Western Polymer Air ring. The extruder was equipped with the following screen pack: 20/40/60/80/20 mesh. Blown films, of about 1.0 mil (25.4 m) thick at 2.5:1 Blow Up Ratio (BUR), were produced at a constant output rate of 100 lb/hr (45.4 kg/hr) by adjusting extruder screw speed, and; the frost line height was maintained at 15-18 inch (38.1-45.72 cm) by adjusting the cooling air. As can be seen from Table 5, at an output rate of 100 lb/hr, the average extrusion pressure of Examples 3-15 was advantageously, lower or comparable relative to Comparative Example 10 and Comparative Example 11.

The film properties of the ethylene interpolymer products of the present disclosure (Examples 3-15) are provided in Table 6A and Table 6B, along with data for films made from Comparative Example 10 and Comparative Example 11. It is noticeable that relative to the films prepared from the Comparative Example, at a given a given LCBF value, Examples 3-15 exhibited a prolonged strain-hardening region in their tensile stress-strain curves in both MD and TD directions (e.g., compare the difference between the tensile yield stress σ_{y} and tensile stress at break σ_{br} in these examples with those observed in the case of Comparatives Examples 10 and 11). For example, in the case of Example 5 and Example 7 having LCBF values which were within the ±5% range of the LCBF value observed for Comparative Example 11, respectively, featured an improvement of 75.3% and 12.5% in their MD direction σ_{br}-σ_{y} relative to the Comparative Example 11. Similarly, Example 4 with an LCBF value of 0.0313 exhibited 79.4% improvement in its MD direction σ_{br}-σ_{y}relative to the Comparative Example 10 which had a LCBF value 0.0291. It was further noticeable that Examples 4, 6 and 11-14, despite having a higher density (i.e., a density >0.9180), exhibited an improved Dart Impact and Lubricated Puncture relative to Comparative Examples 10 and 11; namely, an improvement in their Dart Impact ranging from 6.6% to 117.3% and an improvement in their Lubricated Puncture ranging from 5.7% to 26.7% relative to the Dart Impact and Lubricated Puncture values observed for the Comparative Examples.

TABLE 5
Extrusion Behavior of Examples 1-13, Comparative Examples 10 and
11 Characterized Using a Monolayer Film Blowing Extrusion Line.

| | Melt | | | Pressure | Pressure | Avg. | Screw | Line | Specific | Specific | Specific |
|---|---|---|---|---|---|---|---|---|---|---|---|
| | Temp. | Current | Voltage | High | Low | Pressure | Speed | Speed | Output | Power | Energy |
| | (° F.) | (Amp) | (V) | (psi) | (psi) | (psi) | (rpm) | (ft/min) | (lb/hr/rpm) | ((lb/hr)/amp) | (W/lb/hr) |
| Ex. 1 | 432 | 40 | 203 | 3800 | 3750 | 3775.0 | 42 | 130 | 2.38 | 2.50 | 81.2 |
| Ex. 2 | 432 | 38 | 204 | 3720 | 3665 | 3692.5 | 43 | — | 2.33 | 2.63 | 77.5 |
| Ex. 3 | 433 | 39 | 206 | 3770 | 3725 | 3747.5 | 43 | 130 | 2.33 | 2.56 | 80.3 |
| Ex. 4 | 433 | 39 | 205 | 3765 | 3725 | 3745.0 | 43 | 130 | 2.33 | 2.56 | 80.0 |
| Ex. 5 | 429 | 37 | 200 | 2950 | 2900 | 2925.0 | 42 | 131 | 2.38 | 2.70 | 74.0 |
| Ex. 6 | 432 | 38 | 202 | 3090 | 3040 | 3065.0 | 42 | 131 | 2.38 | 2.63 | 76.8 |
| Ex. 7 | 429 | 36 | 204 | 2875 | 2830 | 2852.5 | 43 | 130 | 2.33 | 2.78 | 73.4 |
| Ex. 8 | 431 | 38 | 198 | 3010 | 2965 | 2987.5 | 42 | 132 | 2.33 | 2.78 | 75.2 |
| Ex. 9 | 429 | 37 | 194 | 2975 | 2935 | 2955.0 | 40 | 130 | 2.50 | 2.70 | 71.8 |
| Ex. 10 | 430 | 36 | 201 | 2920 | 2875 | 2897.5 | 42 | 131 | 2.38 | 2.78 | 72.4 |
| Ex. 11 | 432 | 39 | 195 | 3890 | 3890 | 3890.0 | 41 | 129 | 2.44 | 2.56 | 76.1 |
| Ex. 12 | 431 | 38 | 195 | 3865 | 3795 | 3830.0 | 41 | 128 | 2.44 | 2.63 | 74.1 |
| Ex. 13 | 431 | 40 | 205 | 4040 | 3980 | 4010.0 | 42 | 128 | 2.38 | 2.50 | 82.0 |
| Comp. 10 | 434 | 36 | 190 | 3945 | 3905 | 3925.0 | 40 | 131 | 2.50 | 2.8 | 69.0 |
| Comp. 11 | 430 | 36.2 | 188 | 3840 | 3800 | 3820.0 | 39 | 131 | 2.60 | 2.8 | 68.1 |

TABLE 6A
Monolayer Film (1.0-mil Thickness) Physical Properties: Examples 1-7.

| | Ex. 1 | Ex. 2 | Ex. 3 | Ex. 4 | Ex. 5 | Ex. 6 | Ex. 7 |
|---|---|---|---|---|---|---|---|
| Film Thickness (mil) | 1.0 | 1.0 | 1.0 | 1.0 | 1.0 | 1.0 | 1.0 |
| 1% Secant Modulus MD (MPa) | 154.6 | 190.7 | 162.6 | 193.0 | 163.4 | 161.2 | 152.9 |
| 1% Secant Modulus TD (MPa) | 156.8 | 204.5 | 178.9 | 199.9 | 163.2 | 167.8 | 157.3 |
| 2% Secant Modulus MD (MPa) | 142.6 | 176.5 | 150.5 | 178.5 | 139.3 | 136.1 | 128.9 |
| 2% Secant Modulus TD (MPa) | 143.3 | 188.2 | 164.2 | 183.9 | 135.6 | 139.7 | 130.1 |
| Tensile Stress at Break MD (MPa) | 59.3 | 54.3 | 61.2 | 55.7 | 41.7 | 36.0 | 40.7 |
| Tensile Stress at Break TD (MPa) | 47.8 | 52.0 | 50.3 | 51.0 | 39.1 | 36.7 | 37.6 |
| Elongation at Break MD (%) | 632 | 585.0 | 618.0 | 607.0 | 566.0 | 545.0 | 579.0 |
| Elongation at Break TD (%) | 824.0 | 875.0 | 840.0 | 870.0 | 821.0 | 802.0 | 827.0 |
| Tensile Yield Stress MD (MPa) | 9.0 | 10.7 | 9.5 | 10.8 | 8.5 | 8.1 | 8.0 |
| Tensile Yield Stress TD (MPa) | 8.4 | 11.1 | 9.6 | 11.0 | 8.2 | 8.3 | 7.9 |
| Tensile Elongation at Yield MD (%) | 16.0 | 16.0 | 16.0 | 16.0 | 11.0 | 12.0 | 12.0 |
| Tensile Elongation at Yield TD (%) | 15.0 | 15.0 | 15.0 | 16.0 | 16.0 | 16.0 | 16.0 |
| Tear Resistance MD (g/mil) | 188.0 | 198.0 | 213.0 | 201.0 | 229.0 | 240.0 | 246.0 |
| Tear Resistance TD (g/mil) | 469.0 | 544.0 | 478.0 | 526.0 | 520.0 | 513.0 | 543.0 |
| Dart Impact (g/mil) | 634.5 | 878.0 | 732.7 | 698.0 | 632.0 | 668.0 | 672.0 |
| Lubricated Puncture (J/mm) | 103.1 | 83.2 | 91.4 | 82.1 | 106.4 | 95.4 | 87.8 |

TABLE 6B
Monolayer Film (1.0-mil Thickness) Physical Properties:
Examples 8-13, Comparative Examples 10 and 11.

| | Ex. | Ex. | Ex. | Ex. | Ex. | Ex. | Comp. | Comp. |
|---|---|---|---|---|---|---|---|---|
| | 8 | 9 | 10 | 11 | 11 | 13 | 10 | 11 |
| Film Thickness (mil) | 1.0 | 1.0 | 1.0 | 1.0 | 1.0 | 1.0 | 1.0 | 1.0 |
| 1% Secant Modulus MD (MPa) | 154.9 | 191.8 | 177.4 | 154.0 | 169.0 | 122.0 | 207 | 222 |
| 1% Secant Modulus TD (MPa) | 158.1 | 194.7 | 150.4 | 187.0 | 189.0 | 152.0 | 236 | 251 |
| 2% Secant Modulus MD (MPa) | 130.8 | 161.7 | 185.6 | 148.0 | 161.0 | 121.0 | 174 | 187 |
| 2% Secant Modulus TD (MPa) | 132.1 | 162.3 | 154.6 | 169.0 | 171.0 | 142.0 | 199 | 210 |
| Tensile Stress at Break MD (MPa) | 46.8 | 51.1 | 48.5 | 62.0 | 62.3 | 60.3 | 34.2 | 39.3 |
| Tensile Stress at Break TD (MPa) | 36.6 | 37.1 | 38.3 | 45.2 | 50.2 | 57.5 | 34.1 | 39.5 |
| Elongation at Break MD (%) | 597.0 | 644.0 | 638.0 | 555.0 | 544.0 | 506.0 | 461 | 531 |
| Elongation at Break TD (%) | 809.0 | 814.0 | 840.0 | 680.0 | 692.0 | 709.0 | 618 | 748 |
| Tensile Yield Stress MD (MPa) | 8.1 | 9.8 | 9.2 | 9.1 | 9.7 | 8.3 | 9.8 | 10.0 |
| Tensile Yield Stress TD (MPa) | 8.0 | 9.8 | 9.5 | 9.6 | 9.7 | 8.4 | 10.7 | 10.8 |
| Tensile Elongation at Yield MD (%) | 12.0 | 13.0 | 13.0 | 14.0 | 14.0 | 14.0 | 10 | 9 |
| Tensile Elongation at Yield TD (%) | 16.0 | 16.0 | 17.0 | 13.0 | 14.0 | 14.0 | 10 | 9 |
| Tear Resistance MD (g/mil) | 227.0 | 200.0 | 219.0 | 225.0 | 206.0 | 214.0 | 189 | 321 |
| Tear Resistance TD (g/mil) | 539.0 | 551.0 | 567.0 | 533.0 | 521.0 | 523.0 | 462 | 670 |
| Dart Impact (g/mil) | 692.0 | 623.6 | 642.8 | 606.4 | 774.0 | 915.0 | 569 | 404 |
| Lubricated Puncture (J/mm) | 94.8 | 76.2 | 83.6 | 75.9 | 71.9 | 101.0 | 68 | 66 |

### INDUSTRIAL APPLICABILITY

The multicomponent ethylene interpolymer products disclosed herein may be useful in manufactured articles comprising one or more films or film layers such as, for example, food packaging films.

1. An ethylene interpolymer product comprising:
from 30 to 45 weight percent of a first fraction having a molecular weight distribution index M_{w}/Mₙ of from 1.8 to 4.0; and
from 55 to 70 weight percent of a second fraction having a molecular weight distribution index M_{w}/Mₙ of from 2.0 to 6.0;
wherein the second fraction has a non-comonomer index distribution, NCIDᵢ², having a value characterized by eq.(1a) and eq.(1b);
$${NCID}_{i}^{2} \leq 1.000 - 0.00201 ( log {M}_{i} - log {M}_{o} + 4.93 ) + 0.00137 {( log {M}_{i} - log {M}_{o} + 4.93 )}^{2} - 0.00034 {( log {M}_{i} - log {M}_{o} + 4.93 )}^{3} \qquad eq . ( 1 a )$$
$${NCID}_{i}^{2} \geq 0.730 - 0.00388 ( log {M}_{i} - log {M}_{o} + 4.93 ) + 0.00313 {( log {M}_{i} - log {M}_{o} + 4.93 )}^{2} - 0.00069 {( log {M}_{i} - log {M}_{o} + 4.93 )}^{3} \qquad eq . ( 1 b )$$
wherein, Mₒ is a peak molecular weight that characterizes a molecular weight distribution of the second fraction when fit to a log-normal distribution and Mᵢ is an incremental molar mass that characterizes said molecular weight distribution;
wherein a first semi-log derivative of the NCIDᵢ², d (NCIDᵢ²)/d log Mᵢ, eq.(2),
$$d ( {NCID}_{i}^{2} ) / d log {M}_{i} = {β}_{1} + 2 {β}_{2} ( log {M}_{i} - log {M}_{o} + 4.93 ) + 3 {{β}_{3} ( log {M}_{i} - log {M}_{o} + 4.93 )}^{2} \qquad eq . ( 2 )$$
has a value of ≤−0.0001, wherein coefficients β₀, β₁, β₂, and β₃ are generated by fitting the NCIDᵢ² to a third order polynomial, eq.(3),
$${NCID}_{i}^{2} = {β}_{0} + {β}_{1} ( log {M}_{i} - log {M}_{o} + 4.93 ) + {{β}_{2} ( log {M}_{i} - log {M}_{o} + 4.93 )}^{2} + {{β}_{3} ( log {M}_{i} - log {M}_{o} + 4.93 )}^{3} \qquad eq . ( 3 )$$
wherein the ethylene interpolymer product contains detectable levels of long chain branching as characterized by a dimensionless Long Chain Branching Factor, LCBF, of ≥0.005; and
wherein the ethylene interpolymer product has a sum of unsaturation of ≥0.047 per 100 carbon;
wherein the weight percent and the molecular weight distribution index of the first fraction and the second fraction are obtained by deconvoluting an experimentally measured molecular weight distribution of the ethylene interpolymer product, wherein the weight percent of the first or second fraction is defined as the weight of the first or second fraction divided by the weight of the sum of the first fraction and the second fraction, multiplied by 100, and wherein the NCIDᵢ² is obtained by deconvoluting an experimentally measured non-comonomer index distribution of the ethylene interpolymer product.

2. The ethylene interpolymer product of claim 1, wherein the first fraction has a non-comonomer index distribution, NCIDᵢ¹, characterized by a first semi-log derivative, d (NCIDᵢ¹)/d log Mᵢ, having a value of zero, wherein Mᵢ is an incremental molar mass that characterizes a molecular weight distribution of the first fraction, and wherein the NCIDᵢ¹ is obtained by deconvoluting the experimentally measured non-comonomer index distribution of the ethylene interpolymer product.

3. The ethylene interpolymer product of claim 1, wherein the second fraction has a weight average molecular weight which is less than the weight average molecular weight of the first fraction.

4. The ethylene interpolymer product of claim 1, wherein the ethylene interpolymer product has a density of from 0.910 g/cm³ to 0.930 g/cm³.

5. The ethylene interpolymer product of claim 1, wherein the ethylene interpolymer product has a melt index I₂ of from 0.5 dg/min to 1.5 dg/min.

6. The ethylene interpolymer product of claim 1, wherein the ethylene interpolymer product has a composition distribution breadth index, CDBI₅₀ of from 50 to 75 weight percent.

7. The ethylene interpolymer product of claim 1, wherein the ethylene interpolymer product has a dimensionless Long Chain Branching Factor, LCBF, of ≤0.04.

8. The ethylene interpolymer product of claim 1, wherein the ethylene interpolymer product has a dimensionless Long Chain Branching Factor, LCBF, of ≥0.01.

9. The ethylene interpolymer product of claim 1, wherein the ethylene interpolymer product has a sum of unsaturation of ≤0.07 per 100 carbon.

10. The ethylene interpolymer product of claim 1, wherein the ethylene interpolymer product has a molecular weight distribution index M_{w}/Mₙ of from 2.5 to 5.0.

11. The ethylene interpolymer product of claim 1, wherein the ethylene interpolymer product comprises from 1 to 10 mole percent of one or more than one α-olefin.

12. The ethylene interpolymer product of claim 1, wherein the ethylene interpolymer product comprises from 1 to 8 mole percent of one or more than one α-olefin.

13. The ethylene interpolymer product of claim 1, wherein the one or more than one α-olefin is selected from the group comprising 1-hexene, 1-octene and mixtures thereof.

14. A film layer comprising the ethylene interpolymer product of claim 1.

15. The film layer of claim 14, wherein the film layer is a blown film.

16. A multilayer film structure comprising at least one film layer comprising the ethylene interpolymer product of claim 1.

17. The multilayer film structure of claim 16, wherein the at least one film layer is a blown film.

18. The multilayer film structure of claim 16, wherein the multilayer structure has at least three layers.

19. A multilayer film structure comprising a sealant layer, the sealant layer comprising the ethylene interpolymer product of claim 1.
